(19) United States
(12) Patent Application Publication
(10) Pub. No.: US 2020/0097818 A1
(43) Pub. Date: Mar. 26, 2020

(54) METHOD AND SYSTEM FOR TRAINING BINARY QUANTIZED WEIGHT AND ACTIVATION FUNCTION FOR DEEP NEURAL NETWORKS

(71) Applicants: Xinlin LI, Montreal (CA); Sajad DARABI, Montreal (CA); Mouloud BELBAHRI, Montreal (CA); Vahid PARTOVI NIA, Montreal (CA)

(72) Inventors: Xinlin LI, Montreal (CA); Sajad DARABI, Montreal (CA); Mouloud BELBAHRI, Montreal (CA); Vahid PARTOVI NIA, Montreal (CA)

(21) Appl. No.: 16/582,131

(22) Filed: Sep. 25, 2019

Related U.S. Application Data
(60) Provisional application No. 62/736,630, filed on Sep. 26, 2018.

(51) Int. Cl. G06N 3/08; G06N 3/04; G06F 17/15

(52) U.S. Cl. CPC G06N 3/08; G06F 17/15; G06N 3/0472

(57) ABSTRACT

A method of training a neural network (NN) block for a neural network, including: performing a first quantization operation on a real-valued feature map tensor to generate a corresponding binary feature map tensor; performing a second quantization operation on a real-valued weight tensor to generate a corresponding binary weight tensor; convoluting the binary feature map tensor with the binary weight tensor to generate a convoluted output; scaling the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor; calculating a loss function, the loss function including a regularization function configured to train the scaling factor so that the estimated weight tensor is guided towards the real-valued weight tensor; and updating the real-valued weight tensor and scaling factor based on the calculated loss function.

### CROSS-REFERENCE TO RELATED APPLICATION(S)

The present disclosure claims the benefit of priority to U.S. Provisional Patent Application No. 62/736,630, filed Sep. 26, 2018, entitled “A method and system for training binary quantized weight and activation function for deep neural networks” which is hereby incorporated by reference in its entirety into the Detailed Description of Example Embodiments herein below.

### FIELD

The present disclosure relates to artificial neural networks and deep neural networks, and more particularly to a method and system for training binary quantized weight and activation functions for deep neural network.

### BACKGROUND OF THE INVENTION

Deep Neural Networks

Deep neural networks (DNNs) have demonstrated success for many supervised learning tasks ranging from voice recognition to object detection. The focus has been on increasing accuracy, in particular for image tasks, deep convolutional neural networks (CNNs) are widely used. Deep CNN's learn hierarchical representations, which result in their state of the art performance on the various supervised learning tasks.

However, their increasing complexity poses a new challenge and has become an impediment to widespread deployment in many applications; specifically when trying to deploy such networks to resource constrained and lower-power electronic devices. A typical DNN architecture contains tens to thousands of layers, resulting in millions of parameters. As an example, Alexnet requires 200 MB of memory, VGG-Net requires 500 MB memory. The large model sizes are further exasperated by their computational cost requiring GPU implementation to allow real-time inference. Low-power electronic devices have limited memory, computation power and battery capacity, rendering it impractical to deploy typically DNN's in such devices.

Neural Network Quantization

To make DNNs compatible with resource constrained low power electronic devices (e.g. devices that have one or more of limited memory, limited computation power and limited battery capacity), there have been several approaches developed, such as network pruning, architecture design and quantization. In particular, weight compression using quantization can achieve very large savings in memory, where binary (1-bit) and ternary approaches have been shown to obtain competitive accuracy. Weight compression using quantization may reduce NN sizes by 8-32×. The speed up in computation could be increased by quantizing the activation layers of the DNN. In this way, both the weights and activations are quantized, hence one can replace dot products and network operations with binary operations. The reduction in bit-width benefits hardware accelerators such as FPGAs and dedicated neural network chips, as the building blocks in which such devices operate on largely depend on the bit width.

Related Works

[Courbariaux et al. (2015) (citation provided below)] (BinaryConnect) describes training deep neural networks with binary weights (−1 and +1). The authors propose to quantize real values using the sign function. The propagated gradient applies updates to weights |w|≤1. Once the weights are outside of this region they are no longer updated. A limitation of this approach is that it does not consider binarizing the activation functions. As a follow up work, BNN [Hubara et al. (2016) (citation provided below)] is the first purely binary network quantizing both weights and activations. They achieve comparable accuracy to their prior work on BinaryConnect, but still have a large margin compared to the full precision counterpart and perform poorly on large datasets like ImageNet [Russakovsky et al. (2015) (citation provided below)].

[Gong et al. (2014) (citation provided below)] describe using vector quantization in order to explore the redundancy in parameter space and compress the DNNs. They focus on the dense layers of the deep network with the objective of reducing storage. [Wu et al. (2016b) (citation provided below)] demonstrate that better quantization can be learned by directly optimizing the estimation error of each layer's response for both fully connected and convolutional layers. To alleviate the accuracy drop of BNN, [Rastegari et al. (2016) (citation provided below)] proposed XNOR-Net, where they strike a trade-off between compression and accuracy through the use of scaling factors for both weights and activation functions. Rastegari et al. (2016) show performance gains compared to the BNN on ImageNet classification. Though this introduces complexity in implementing the convolution operations on the hardware, and the performance gains aren't as much as if the whole network were truly binary. DoReFa-Net [Zhou et al. (2016) (citation provided below)] further improves XNOR-Net by approximating the activations with more bits. The proposed rounding mechanism allows for low bit back-propagation as well. Although, the method proposed by Zhou et al. (2016) performs multi-bit quantization, it suffers large accuracy drop upon quantizing the last layer. Later in ABC-Net, [Tang et al. (2017) (citation provided below)] propose several strategies: the most notable is adjusting the learning rate for larger datasets, in which they show BNN to achieve similar accuracy as XNOR-Net without the scaling overhead. Tang et al. (2017) also suggest a modified BNN, where they adopted the strategy of increasing the number of filters, to compensate for accuracy loss as done in wide reduced-precision networks [Mishra et al. (2017) (citation provided below)].

More recently, [Cai et al. (2017) (citation provided below)] propose a less aggressive approach to quantization of the activation layers. The authors propose a half-wave Gaussian quantizer (HWGQ) for forward approximation and show to have efficient implementation with 1-bit binary weights and 2-bit quantized activations, by exploiting the statistics of the network activations and batch normalization operations. This alleviates the gradient mismatch problem between the forward and backward computations. ShiftCNN [Gudovskiy and Rigazio (2017) (citation provided below)] is based on a power-of-two weight representation and, as a result, performs only shift and addition operations. [Wu et al. (2018) (citation provided below)] suggest quantizing networks using integer values to discretize both training and inference, where weights, activations, gradients and errors among layers are shifted and linearly constrained to low-bit width integers.

When using low-bit DNNs, there is a drastic drop in inference accuracy compared to full precision NN counterparts (full precision may for example refer to an 8-bit or greater width weight). This drop in accuracy is made even more severe upon quantizing the activations. This problem is largely due to noise and lack of precision in the training objective of the neural networks during back-propagation. Although quantizing weights and activations have been attracting large interest due to its computational benefits, closing the gap between full precision NNs and quantized NNs remains a challenge. Indeed, quantizing weights cause drastic information loss and make neural networks harder to train due to large number of sign fluctuations in the weights. How to control the stability of this training procedure is of high importance. Back-propagation in a quantized setting is infeasible as approximations are made using discrete functions. Instead, heuristics and reasonable approximations must be made to match the forward and backward passes in order to result in meaningful training. Often weights at different layers in the DNNs follow certain structure. Training these weights locally, and maintaining a global structure to minimize a common cost function is important.

Quantized NNs are of particular interest in computationally constrained environments that may for example arise in the software and/or hardware environments provided by edge devices where memory, computation power and battery capacity are limited. NN compression techniques may for example be applied in cost-effective computationally constrained devices, such as the edge devices, that can be implemented to solve real-world problems in applications such as robotics, autonomous driving, drones, and the internet of things (IOT).

Low-bit NN quantization solutions, as noted above, have been proposed as one NN compression technique to improve computation speed. The low-bit NN quantization solutions can be generally be classified into two different categories: (i) weight quantization solutions that only quantize weight but use a full-precision input feature map (the input feature map is an input of a layer of a NN block), the full-precision feature map therefore means that input feature map is not quantized; and (ii) weight/feature map solutions that quantize both weight and input feature map.

Although a number of different low-bit neural network quantization solutions have been proposed, they suffer from deficiencies in respect of one or more of high computational costs or low accuracy of computation compared to a full precision NN where both weights and input feature maps are employed into a NN block with values (e.g., multidimensional vectors or matrix) that are not quantized or binarized.

Accordingly, a NN block that can improve accuracy of computation and reduce one or more of computational costs and memory requirements associated with a NN is desirable.

### SUMMARY OF THE INVENTION

The present disclosure describes a method for training a neural network (NN) block in a NN by applying a trainable scaling factor on output of a binary convolution, which may help to save computational cost significantly and improve computation accuracy to approximate to a full-precision NN. A regularization function with respect to an estimated real-valued weight tensor including the scaling factor and a real-valued weight tensor is included in a loss function of the NN. In a forward pass, pushing the estimated real-valued weight tensor and the real-valued weight tensor to be close with each other enables the regularization function to be zero, which may help to improve stability of the NN and help to train the scaling factor and the real-valued weight tensor with greater accuracy. In addition, one or more smooth differentiable function are used as quantization function in a backward pass to calculate partial derivatives of loss function with respect to real-valued weight tensor and real-valued input feature map.

According to a first example aspect is a method of training a neural network (NN) block for a neural network. The method comprises: performing a first quantization operation on a real-valued feature map tensor to generate a corresponding binary feature map tensor; performing a second quantization operation on a real-valued weight tensor to generate a corresponding binary weight tensor; convoluting the binary feature map tensor with the binary weight tensor to generate a convoluted output; scaling the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor; calculating a loss function, the loss function including a regularization function configured to train the scaling factor so that the estimated weight tensor is guided towards the real-valued weight tensor; and updating the real-valued weight tensor and scaling factor based on the calculated loss function.

In accordance with the preceding aspect, the method further comprises: during backpropagation, using differential functions that include a sigmoid function to represent the first quantization operation and the second quantization operation.

In accordance with any of the preceding aspects, the differentiable function is:

y_{β}(x)=2σ(βx)[1+βx(1−σ(βx))]−1, wherein:

σ(.) is a sigmoid function;

β is a parameter which is variable that controls how fast the differentiable function converges to a sign function; and

X is the quantized value.

In accordance with any of the preceding aspects, the method further comprises: the first quantization operation and the second quantization operation each include a differential functions that include a sigmoid function.

In accordance with any of the preceding aspects, the regularization function is based on an absolute difference between the estimated weight tensor and the real-valued weight tensor.

In accordance with any of the preceding aspects, the regularization function is based on a squared difference between the estimated weight tensor and the real-valued weight tensor.

In accordance with any of the preceding aspects, the scaling factor includes non-binary real values.

In accordance with any of the preceding aspects, the neural network includes N of the NN blocks, and the loss function is:

Loss=a criterion function+sum_i(reg(αᵢ*Wᵢ^{b},Wᵢ))

where the criterion function represents differences between a computed output and a target output for the NN, sum_i is a summation of the regularization functions in different blocks 1 to N of the neural network, i is in the range from 1 to N; and reg (αᵢ*Wᵢ^{b}, Wᵢ) represents the regularization function where αᵢ*Wᵢ^{b} is the estimated weight tensor and Wᵢ is the real-valued weight tensor Wᵢ.

According to a second example aspect is a processing unit implementing an artificial neural network. The artificial neural network comprises a neural network (NN) bock. The NN block is configured to: perform a first quantization operation on a real-valued feature map tensor to generate a corresponding binary feature map tensor; perform a second quantization operation on a real-valued weight tensor to generate a corresponding binary weight tensor; convolute the binary feature map tensor with the binary weight tensor to generate a convoluted output; scale the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor; a training module configured to: calculate a loss function, the loss function including a regularization function configured to train the scaling factor so that the estimated weight tensor is guided towards the real-valued weight tensor; and update the real-valued weight tensor and scaling factor based on the calculated loss function.

In accordance with a broad aspect, during backpropagation differential functions that include a sigmoid function are used as to represent the first quantization operation and the second quantization operation.

In accordance with a broad aspect, the differentiable function is:

y_{β}(x)=2σ(βx)[1+βx(1−σ(βx))]−1, wherein:

σ(.) is a sigmoid function;

β is a parameter which is variable that controls how fast the differentiable function converges to a sign function; and

X is the quantized value.

In accordance with a broad aspect, during forward propagation the first quantization operation and the second quantization operation each include a differential functions that include a sigmoid function.

In accordance with a broad aspect, the regularization function is based on an absolute difference between the estimated weight tensor and the real-valued weight tensor.

In accordance with a broad aspect, the regularization function is based on a squared difference between the estimated weight tensor and the real-valued weight tensor.

In accordance with a broad aspect, the scaling factor includes non-binary real values.

In accordance with a broad aspect, the neural network includes N of the NN blocks, and the loss function is:

Loss=a criterion function+sum_i(reg(αᵢ*Wᵢ^{b},Wᵢ))

where the criterion function represents differences between a computed output and a target output for the NN, sum_i is a summation of the regularization functions in different blocks 1 to N of the neural network, i is in the range from 1 to N; and reg (αᵢ*Wᵢ^{b}, Wᵢ) represents the regularization function where αᵢ*Wᵢ^{b} is the estimated weight tensor and Wᵢ is the real-valued weight tensor Wᵢ.

### BRIEF DESCRIPTION OF THE DRAWINGS

Reference will now be made, by way of example, to the accompanying drawings which show example embodiments of the present application, and in which:

FIG. 1 is a computational graph representation of a known NN block of an NN;

FIG. 2 is another computational graph representation of a known NN block;

FIG. 3 is another computational graph representation of a known NN block;

FIG. 4 is another computational graph representation of a known NN block;

FIG. 5A graphically represents a sign function in a two dimensional coordinate plot;

FIG. 5B graphically represents a conventional function approximating the sign function in a two dimensional coordinate plot;

FIG. 6A is a computational graph representation of an NN block performing forward propagation according to an example embodiment;

FIGS. 6B-6E are examples of different variables applied in the NN block of FIG. 6A.

FIG. 6F is a computational graph representation of an NN block performing backward propagation according to a further example embodiment;

FIG. 6G is a schematic diagram illustrating an example method for training the NN block of FIG. 6A;

FIGS. 7A and 7B graphically represent a respective regularization function included in the loss function of FIG. 6A;

FIGS. 8A and 8B graphically represent a respective differentiable function in a two dimensional coordinate plot, the respective differentiable function is applied in the NN block of FIG. 6F for quantization;

FIG. 9 is a block diagram illustrating an example processing system that may be used to execute machine readable instructions of an artificial neural network that includes the NN block of FIG. 6A.

FIGS. 10A and 10B graphically represent a respective regularization function in accordance with another examples;

FIG. 11 is a block diagram showing an example of facial recognition in accordance with further example;

FIG. 12 is a schematic diagram showing an example of ConvNet architecture of DeepID2 feature extractor in accordance with further example;

FIG. 13 is a schematic diagram showing an example of using a region proposal network in accordance with further example;

FIG. 14 is a schematic diagram showing an example of one-stage approach in accordance with further example;

FIG. 15 is a schematic diagram showing an example of faster R-CNN in accordance with further example;

FIG. 16 is a schematic diagram showing an example of YOLO in accordance with further example;

FIG. 17 is a schematic diagram showing an example 2D CNN in accordance with further example;

FIG. 18 is a schematic diagram showing an example method of motion-based feature in accordance with further example;

FIG. 19 is a schematic diagram showing an example 3D CNN in accordance with further example;

FIG. 20 is a schematic diagram showing an example method of temporal deep-learning in accordance with further example;

FIG. 21 is a schematic diagram showing an example two-stream CNN architecture in accordance with further example;

FIG. 22 is a schematic diagram showing an example of 2D convolution and 3D convolution in accordance with further example;

FIG. 23 is a schematic diagram showing an example CNN-LSTM architecture in accordance with further example;

FIG. 24 is a schematic diagram showing an example of sentiment analysis in accordance with further example;

Similar reference numerals may have been used in different figures to denote similar components.

### DESCRIPTION OF EXAMPLE EMBODIMENTS

Example embodiments relate to a novel method of quantization for training 1-bit CNNs. The methods disclosed include aspects related to:

Regularization.

A regularization function facilitates robust generalization, as it is commonly motivated by L₂ and L₁ regularizations in DNNs. A well structured regularization function can bring stability to training and allow the DNNs to maintain a global structure. Unlike conventional regularization functions that shrink the weights to 0, in the context of a completely binary network, in example embodiments a regularization function is configured to guide the weights towards the values −1 and +1. Examples of two new L₁ and L₂ regularization functions are disclosed which make it possible to maintain this coherence.

Scaling Factor.

Unlike XNOR-net which introduces scaling factors for both weights and activation functions in order to improve binary neural networks, but which complicates and renders the convolution procedure ineffective in terms of computation, example embodiments are disclosed wherein the scaling factors are included directly into the regularization functions. This facilitates the learning of scaling factor values with back-propagation. In addition, the scaling factors are constrained to be in binary form.

Activation Function.

As weights in a convolutional layer are largely centered at zero, binarizing the activation at these layers incur large information loss. Moreover, since the sign function that binarizes the activation is not differentiable, according to example embodiments, the derivative of a sign function is approximated by the derivative of a learnable activation function that is trained jointly with the NN. The function depends on one scale parameter that controls how fast the activation function converges to the sign function.

Initialization.

As with the activation function, according to example embodiments a smooth surrogate of the sign function is used for initialization. The activation function is used in pre-training.

Example embodiments provide a method of training 1-bit CNNs which may in some cases improve a quantization procedure. Quantization through binary training involves quantizing weights are quantized by using the sign function:

$${w}^{b} = sign ( w ) = f ( x ) = \{ \begin{matrix}+ 1 , & w \geq 0 \\ - 1 , & otherwise\end{matrix}$$

During forward propagation the real value weights are binarized to w^{b}, and a loss is computed using binary weights. In a conventional low-bit solution, on back-propagation the sign function is almost zero everywhere, and hence would not enable learning in the network. To alleviate this problem, in example embodiments a straight through estimator is used for the gradient of the sign function. This method is a heuristic way of approximating the gradient of a neuron,

$$\frac{\partial L}{\partial w} = \frac{\partial L}{\partial {w}^{b}} {1}_{\vert w \vert \leq 1}$$

where L is the loss function and 1 is the indicator function.

Regularization Function

Regularization can be motivated as a technique to improve the generalizability of a learned NN model. Instead of penalizing the magnitude of the weights by a function whose minimum is reached at 0, to be consistent with the binarization, a function is defined that reaches two minimums. The idea is to have a symmetric function in order to generalize to binary networks and to introduce a scaling factor α that we can factorize. It can be seen that, when training the network, the regularization term will guide the weights to −α and +α.

The L₁ regularization function is defined as

p₁(α,x)=|α−|x||

whereas the L₂ version is defined as

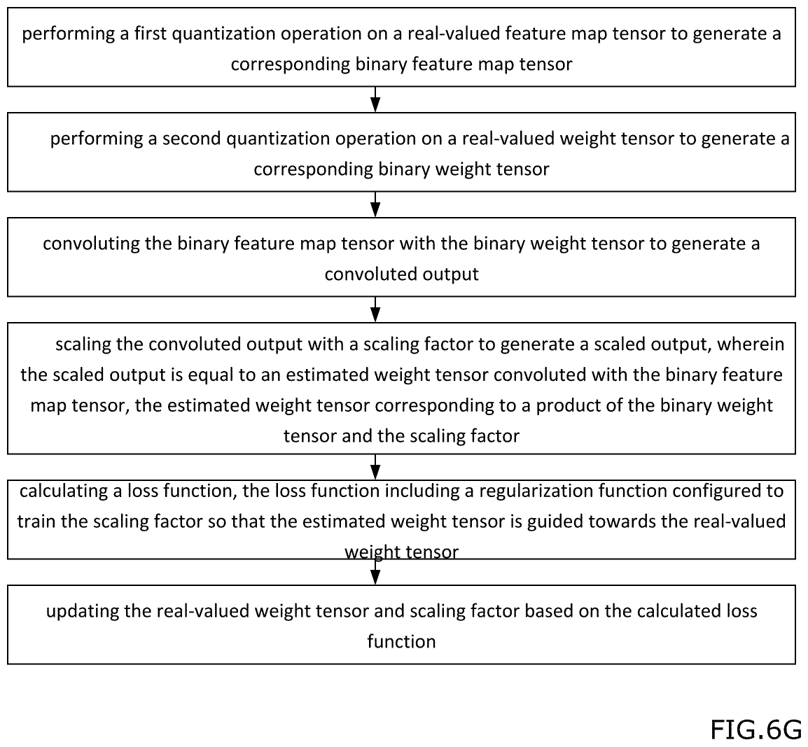

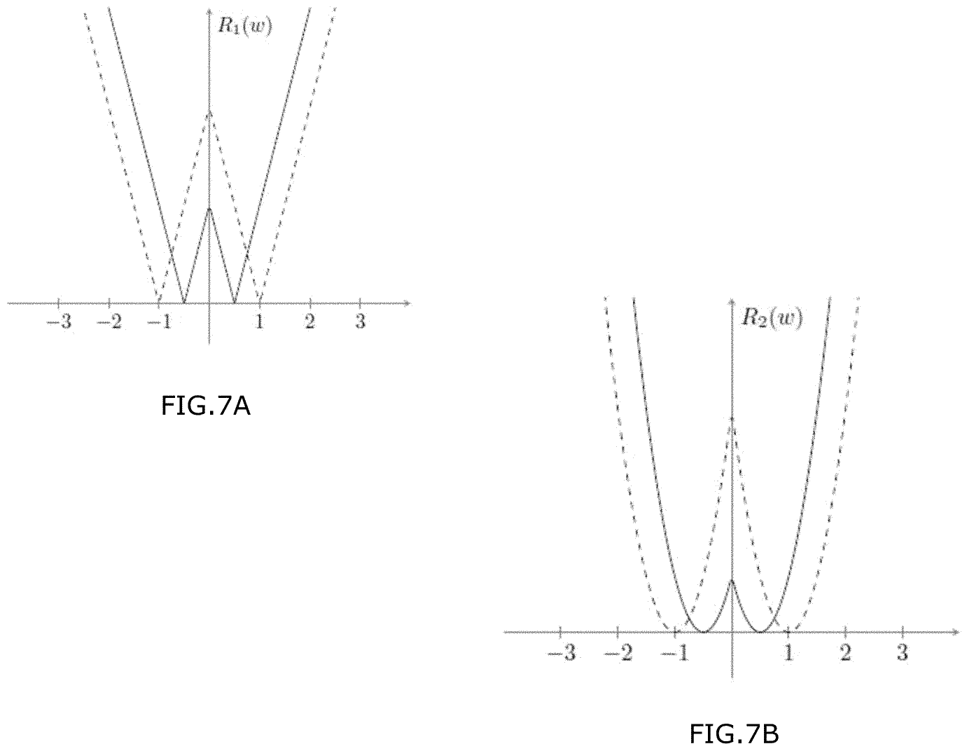

p₂(α,x)=(α−|x|)²

where α>0 is the scaling factor. As depicted in FIGS. 10A and 10B, in the case of α=1 the weights are penalized at varying degrees upon moving away from the objective quantization values, in this case {−1,1}. FIG. 10A shows L_1 regularization functions for α=1, and FIG. 10B shows L_2 regularization functions for α=1.

Activation Function

The choice of activation functions in DNNs has a significant effect on the training dynamics and task performance. For binary NNs, since the sign function that binarizes the activation is not differentiable, example embodiments approximate its derivative by the derivative of a learnable activation function that is trained jointly with the network. The function depends on one scale parameter that controls how fast the activation function converges to the sign function. According to example embodiments, a new activation function is defined that is inspired by the derivative of the SWISH function, called Sign SWISH or SSWISH.

The SSWISH function is defined as:

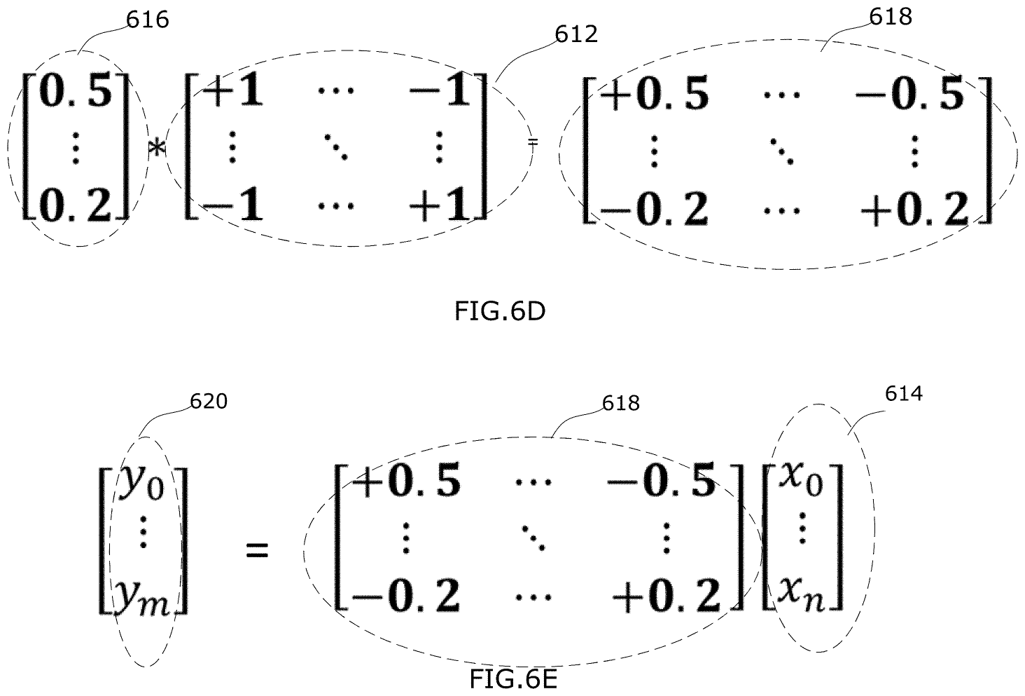

α_{β}(x)=2σ(βx)[1+βx(1−σ(βx))]−1

where σ(z) is the sigmoid function and the scale β>0 controls how fast the activation function asymptotes to −1 and 1 (see FIGS. 8A and 8B; FIG. 8A shows a SSWISH function for β=2 and FIG. 8B shows a SSWISH function for β=10.)

Example embodiments will now be described in greater detail.

The present disclosure is directed to a NN block, such as a bit-wise NN block that may, in at least some applications, better approximate a full-precision NN block than an existing low-bit NN blocks. In at least some configurations, the disclosed NN block may require fewer computational and/or memory resources, and may be included in a trained NN that can effectively operate in a computationally constrained environment with limited memory, computation power and battery. The present disclosure is directed to a bit-wise NN block that is directed towards using a trainable scaling factor on a binary convolution operation and incorporating a regularization function in a loss function of a NN to constrain an estimated real-valued weight tensor to be close to a real-valued weight tensor. The estimated real-valued weight tensor is generated by element-wise multiplying the scaling factor with a binary weight tensor. In the forward pass, when the estimated real-valued weight tensor is varied, the scaling factor is adjusted to collectively enable the regularization function to be around zero. Such a method using the regularization function may enable the scaling factor to be trained more accurately. As well, the scaling factor may ensure precision of the bit-wise NN block to be close to a full-precision NN block. Furthermore, one or more differentiable functions are used as binary quantization functions to calculate derivatives of a loss function with respect to real-valued weight tensor and with respect to real-valued input feature maps respectively in a backward pass of an iteration for a layer of the NN block. Each differentiable function may include a sigmoid function. Utilization of the differentiable functions in backward propagation may help to reduce computational loss incurred by the non-differentiable functions in the backward pass.

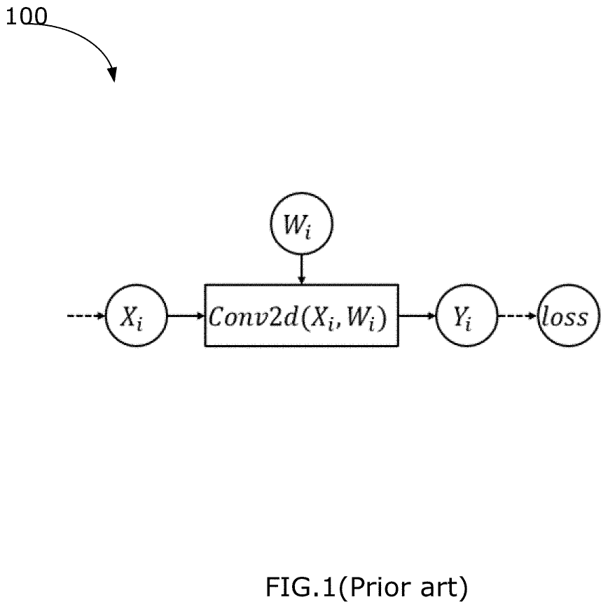

FIGS. 1 to 5B are included to provide context for example embodiments described below. FIG. 1 shows a computational graph representation of a conventional basic neural network (NN) block 100 that can be used to implement an ith layer of an NN. The NN block 100 is a full-precision NN block that performs multiple operations on an input feature map tensor that is made of values that each have 8 or more bits. The operations can include, among other things: (i) a matrix multiplication or convolution operation, (ii) an addition or batch normalization operation; and (iii) an activation operation. The full-precision NN block is included in a full-precision NN. For ease of illustration, although NN block 100 may include various operations, these operations are represented as a single convolution operation in FIG. 1, (e.g., a convolution operation for the ith layer of the NN) and the following discussion. In this regard, the output of NN block 100 is represented by equation (1):

Yᵢ=Xᵢ₊₁=Conv2d(WᵢXᵢ) (1)

Where Conv2d represents a convolution operation;

Wᵢ represents a real-valued weight tensor for the i th layer of the NN (i.e., the NN block 100), the real-valued weight tensor Wᵢ includes real-valued weights for the i th layer of the NN (i.e., the NN block 100) (note that weight tensor Wᵢ can include values that embed an activation operation within the convolution operation);

Xᵢ represents a real-valued input feature map tensor for the i th layer of the NN, the real-valued input feature map tensor Xᵢ includes one or more real-valued input feature maps for the i th layer of the NN (i.e., the NN block 100);

Yᵢ or Xᵢ₊₁ represents a real-valued output. For ease of illustration and for being consistent in mathematical notation, following discussion will use uppercase letters, such as W, X, Y, to represent tensors, and lowercase letters, such as x,w, will be used to represent elements within each tensor. In some examples, a tensor can be a vector, a matrix, or a scalar. Furthermore, the following discussion will illustrate an NN block implemented on ith layer of a NN.

Because each output Yᵢ is a weighted sum of an input feature map tensor Xᵢ, which requires a large number of multiply-accumulate (MAC) operations, the high-bit operations performed by a full-precision NN block 100 are computationally intensive and thus may not be not suitable for implementation in resource constrained environments.

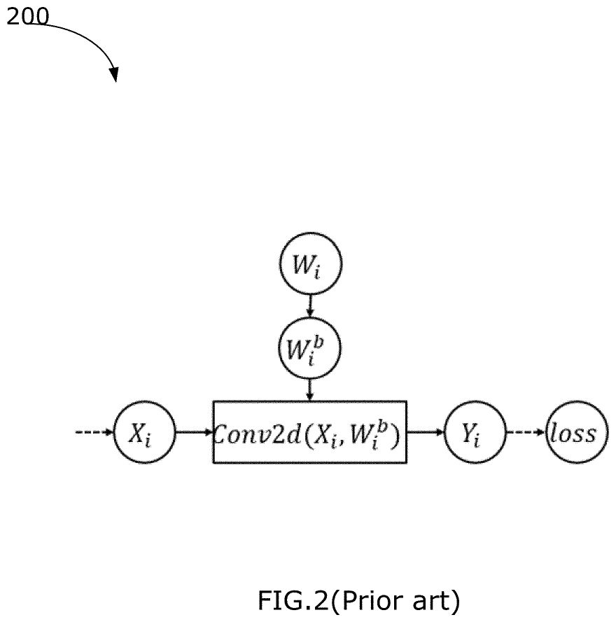

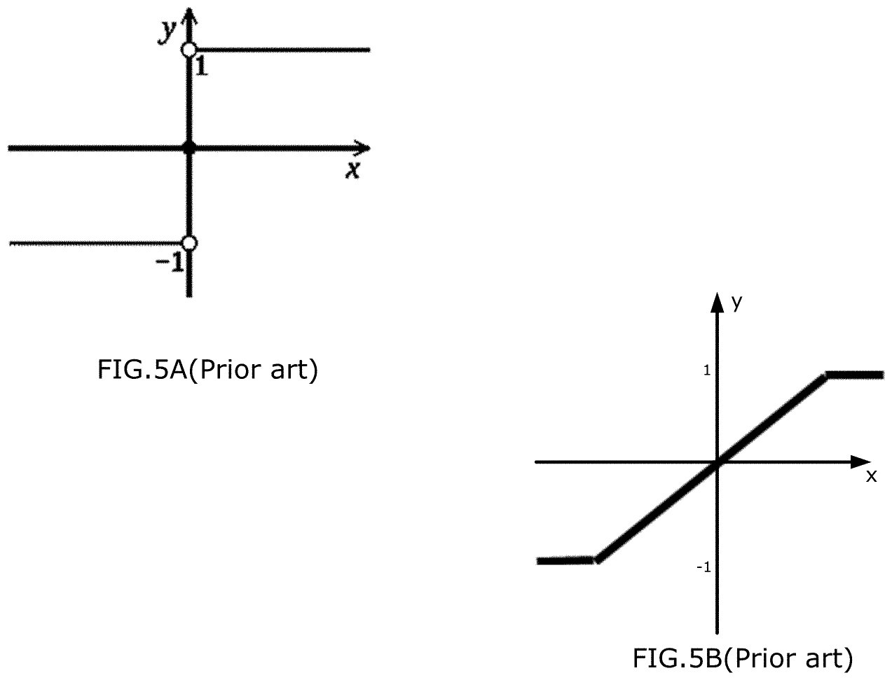

FIG. 2 shows an example of an NN block 200 in which elements of a real-valued weight tensor, represented by Wᵢ, are quantized into binary values (e.g., −1 or +1), denoted by Wᵢ^{b}, during a forward pass of an iteration on the ith layer. Quantizing the real-valued weight tensor to binary values is performed by a sign function represented by a plot shown in FIG. 5A. A binary weight tensor denoted by equation (2):

$${W}_{i}^{b} = sign ( {W}_{i} ) \\ {w}^{b} = sign ( w ) = f ( x ) = \{ \begin{matrix}+ 1 , & w \geq 0 \\ - 1 , & otherwise\end{matrix} \qquad ( 2 )$$

Where Wᵢ^{b} represents a binary weight tensor including at least one binary weights; and sign(.) represents the sign function used for quantization. It is noted that in following discussion, any symbol having a superscript b represent that symbol is a binary value or a binary tensor in which elements are binary values.

The NN block 200 can only update each element of the real-valued weight tensor in a range of |wⁱ|≤1. If values of the real-valued weights are outside of the range (e.g., [−1, 1]), the real-valued weights will not be updated or trained any more, which may cause the NN block 200 to be trained inaccurately.

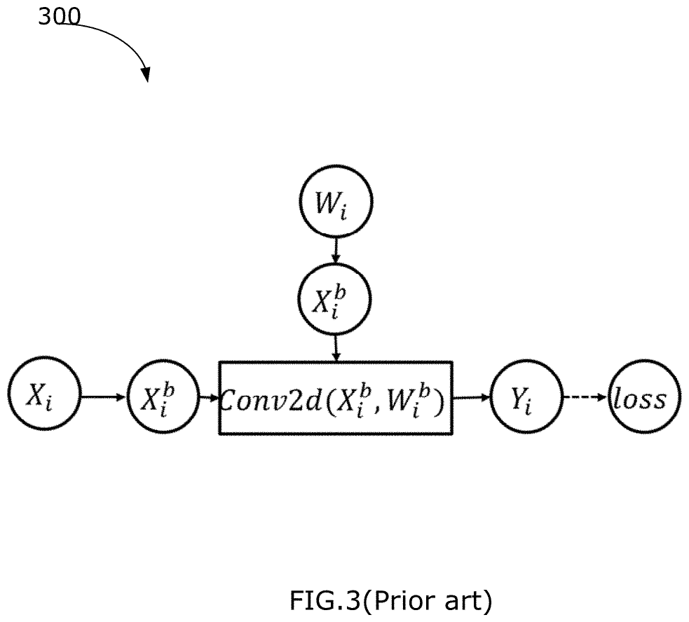

FIG. 3 shows an example of an NN block 300 in which both elements of real-valued weight tensor Wᵢ and elements of real-valued input feature map tensor Xᵢ are quantized during a forward pass into binary tensors Wᵢ^{b} and Xᵢ^{b} within which each element has a binary value (e.g., −1 or +1). The NN block 300 of FIG. 3 is similar to the NN block 200 of FIG. 2 except that elements (e.g., real-valued input feature maps) of real-valued input feature maps Xᵢ are quantized as well. The quantization of real-valued weights Wᵢ and real-valued input feature maps Xᵢ are performed by a sign function (e.g., as shown in FIG. 5A, which will be discussed further below) respectively during the forward pass. However, the NN block 300 has poor performance on large datasets, such as ImageNet datasets.

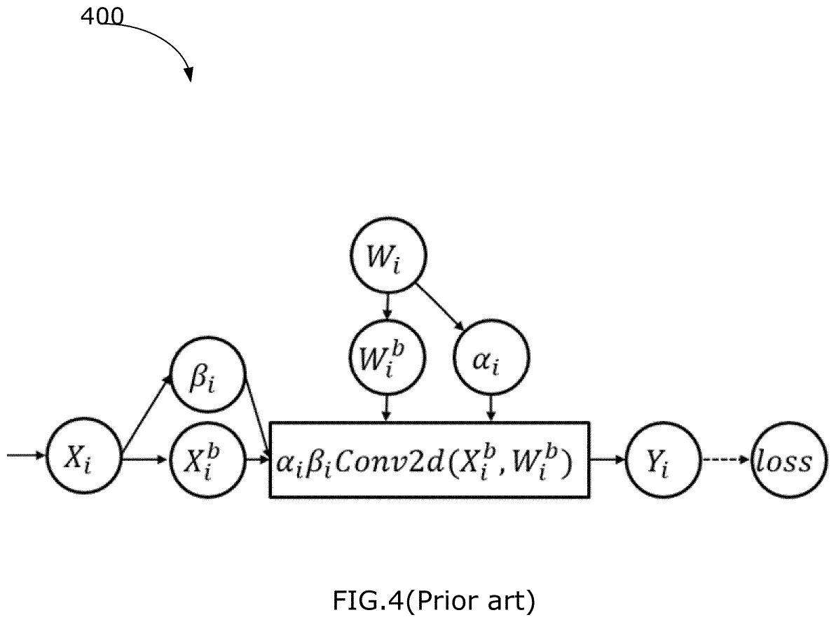

FIG. 4 is an example of an NN block 400 in which a scaling factor αᵢ and a scaling factor βᵢ are applied to scale a binary weight tensor and a binary input feature map tensor respectively. In the NN block 400, the scaling factor αᵢ and the scaling factor βᵢ are generated based on the real-valued input feature map tensor and the real-valued weight tensor. Although precision of the NN block 400 is improved compared to that of NN block 300, computational cost is introduced into the NN block 400 greatly because values of the scaling factors βᵢ are determined by values of the real-valued input feature map tensor.

FIG. 5A is a plot of a typical sign function which is used to quantize real-valued weights in a real-valued weight tensor and/or real-valued input feature maps in a real-valued input feature map tensor, as discussed in conventional approaches as demonstrated in FIGS. 2-4, during a forward pass. As the sign function is inconsistent, non-differentiable and may cause a great deal of loss in back propagation, the conventional methods as illustrated in FIGS. 2-4 employ a consistent function as shown in FIG. 5B to approximate the sign function to perform quantization during a backward pass. The consistent function of FIG. 5B is denoted by equation (3) as below.

$$y = \{ \begin{matrix}1 , & x > 1 \\ x , & - 1 \leq x \leq 1 \\ - 1 , & x < - 1\end{matrix} \qquad ( 3 )$$

By comparing the plots of the sign function in FIG. 5A and the consistent function in FIG. 5B, it noted that when −1≤x≤1, the function represented by y=x as shown in FIG. 5B converges to the real values (e.g., −1 or +1) of the sign function inaccurately. There is a substantial discrepancy between an actual sign function and the approximated consistent function in FIG. 5B when the backward propagation is performed within the range −1≤x≤1.

The present disclosure describes a method of training a NN block in which a regularization function is included in a loss function of a NN including the NN block to update or train real-valued weights of a real-valued weight tensor and a scaling factor, which may help to update the real-valued weights and the scaling factor with greater accuracy. Furthermore, one or more differentiable functions are used to approximate sign functions during a backward pass, which respectively quantize the real-valued weights of the real-valued tensor and the real-valued input feature maps of a real-valued input feature map tensor. Such a method of utilizing smooth differentiable functions to approximate non-differentiable functions during the backward pass may enable partial derivatives of the loss function with respect to input feature map tensor and partial derivatives of the loss function with respect to input feature map tensor, which may help to improve accuracy of training the NN block accordingly.

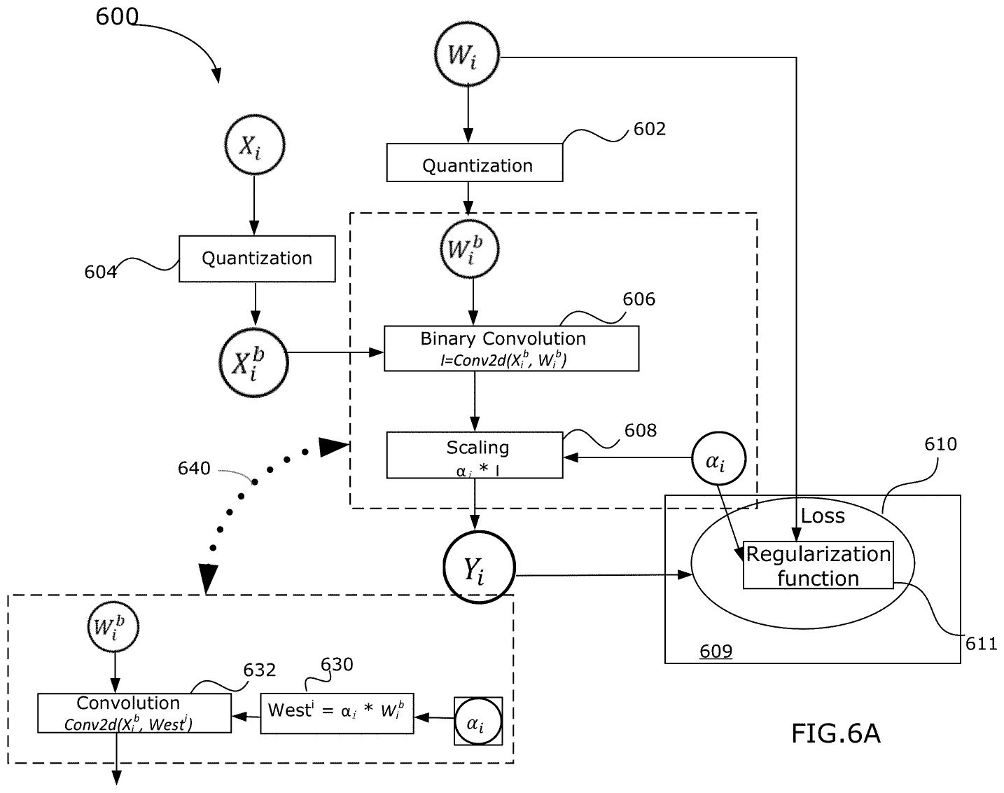

In this regard, FIG. 6A represents a bit-wise NN block 600 performing a forward pass of an iteration on an ith layer of a NN in accordance with example embodiments. In the NN block 600, a trainable scaling factor αᵢ is applied on the output of a binary convolution operation, which may help to improve precision of the NN block 600. In some examples, the NN block 600 may be a CNN block implemented in an ith layer of a CNN. With respect to training, the NN block 600 implemented in the ith layer of a NN, a plurality of iterations are performed on the ith layer of the NN. In some examples, each iteration involves steps of: forward pass or propagation, loss calculation, and backward pass or propagation (including parameter update) (e.g., including parameters such as weights Wᵢ, the scaling factor αᵢ, and a leaning rate). For ease of illustration, steps in one iteration (e.g., kth iteration) on the ith layer will be discussed further below.

In an example embodiment, real valued NN block 600 comprises a layer in an NN that is trained using a training dataset that includes a real-valued input feature map tensor X and with a corresponding set of labels Y^{T}.

As shown in FIG. 6A, the NN block 600 includes two binary quantization operations 602, 604, a binary convolution operation 606 (Conv2d(Xᵢ^{b},Wᵢ^{b})), and a scaling operation 608. The binary quantization operation 602 quantizes real-valued input feature map tensor Xᵢ to a respective binary feature map tensor Xᵢ^{b} and binary quantization operation 604 quantizes real-valued weight tensor Wᵢ into a respective binary weight tensor Wᵢ^{b}.

FIG. 6B illustrates a binary weight tensor Wᵢ^{b} 612 for NN block 600, and FIG. 6C illustrates an example of a binary feature map tensor Xᵢ^{b} 614. As shown in FIG. 6B, binary weight tensor Wᵢ^{b} 612 is a two dimensional matrix. As shown in FIG. 6C, the elements of a single matrix column (e.g. a column vector) form binary input feature map Xᵢ^{b} 614. In this example, the binary weight tensor Wᵢ^{b} 612 and the binary feature map tensor Xᵢ^{b} 614 are generated in a forward pass of the kth iteration on the ith layer of the NN. In example embodiments, binary quantization operations 602, 604 performed during the forward pass are based on the sign function of equation (2) and illustrated in FIG. 5A in order to quantize each real-valued input feature map xᵢ and each real-valued weight wᵢ respectively. Thus, the binary weights included in the binary weight tensor Wᵢ^{b} 612 are defined by the equation (2) as discussed above. The binary feature map tensor Xᵢ^{b} 614 is denoted by equation (4) as below:

Xᵢ^{b}=sign(Xᵢ) (4)

Where Xᵢ^{b} represents the binary input feature map tensor 614; sign (.) represents the sign function used for quantization in the forward pass.

The binary convolution operation 606 then convolutes the binary weight tensor Wᵢ^{b} 612 with the binary feature map tensor Xᵢ^{b} 614 and generates an output i=Conv2d(Xᵢ^{b},Wᵢ^{b}). The scaling operation 608 uses a trainable scaling factor αᵢ to scale the output of the binary convolution operation 606 and generates a scaled output αᵢ*I. The scaled output, which is also an output of the NN block 600 in this example, is denoted by equation (5) as below:

Yᵢ=αᵢ*Conv2d(Xᵢ^{b},Wᵢ^{b}) (5)

Where Conv2d represents a binary convolution operation; αᵢ represents the scaling factor; Xᵢ^{b} represents the binary feature map tensor; and Wᵢ^{b} represents the binary weight tensor.

In the example where the scaling factor αᵢ is a column vector of scalar values, the scaled output feature map tensor Yᵢ as denoted by equation (5) can also be represented by equation (6) below:

Yᵢ=Conv2d(Xᵢ^{b},αᵢ*Wᵢ^{b}) (6)

Where αᵢ*Wᵢ^{b} is referred to as an estimated real-valued weight tensor West′, which is represented by equation (7) below:

Westⁱ=αᵢ*Wᵢ^{b} (7)

Where * represents an element-wise multiplication; scaling factor αᵢ is a column vector of scaler values.

Accordingly, as shown by dashed arrow 640 in FIG. 6A binary convolution and scaling operations 606 and 608 can be alternatively be represented as a binary weight scaling operation 630 that outputs estimated real-valued weight tensor Westⁱ, followed by convolution operation 632 Conv2d(Xᵢ^{b},Westⁱ).

For each layer (e.g., the ith layer, i is an integer) of the NN, a different respective scaling factor αᵢ is used to perform the element-wise multiplication and applied to the NN block to generate a respective Yᵢ. FIG. 6D demonstrates an example of binary weight scaling operation 630 wherein estimated real-valued weight tensor Westⁱ 618 is generated by element-wise multiplying a binary weight tensor Wᵢ^{b} 612 with a scaling factor αᵢ 616. FIG. 6E shows an example of convolution operation 632 wherein the scaled output feature map tensor Yᵢ (denoted as 620) can be represented by the estimated real-valued weight tensor Westⁱ 618 convoluted with the binary input feature map Xᵢ^{b} 614, as per equation (6). In the example of FIGS. 6B to 6E, NN block 600 has m input channels and n output channels, and estimated real-valued weight tensor Westⁱ 618 and binary weight tensor Wᵢ^{b} 612 are each m by n matrices.

Because each estimated real-valued weight tensor West′ 618 is diversified to include real values rather than just binary values (e.g., −1 or +1), precision of the bit-wise NN block 600 may be improved significantly in at least some applications. It is noted that the closer that the estimated real-valued weight tensor West′ 618 approximates the real-valued weight tensor Wᵢ, the greater precision bit-wise NN block 600 will have and the closer bit-wise NN block 600 will approximate a full-precision NN block.

Referring to FIG. 6A again, the NN block 600 interacts with a training module 609 of the NN. The training module 609 is configured to calculate a loss function 610 and perform backpropagation to calculate and update parameters of the NN, including parameters for NN block 600. A regularization function 611 is incorporated in the loss function 610 in order to constrain the estimated real-valued weight tensor Westⁱ (which incorporates scaling factor αᵢ) to approximate the real-valued weight tensor Wᵢ. This can help to improve stability of the NN block 600. The loss function 610 including the regularization function 611 is used to measure discrepancy or errors between a target output Y^{T}ᵢ and an actual output Yᵢ computed when the NN block 600 performs forward propagation as discussed above in the kth iteration. In this example, the loss function Loss 610 includes terms for regulating both the estimated real-valued weight tensor Westⁱ=αᵢ*Wᵢ^{b} and the real-valued weight tensor Wᵢ.

In some examples, the regularization function 611 is used to impose a penalty on complexity of the loss function 610 and may help to improve generalizability of the NN block 600 and to avoid overfitting. For example, if the regularization function 611 approximates to zero, the output of NN block 600 will be less affected by noise in input feature maps. In this regard, generalization of the NN block 600 is improved, and the NN block 600 becomes more reliable and stable. Thus, minimizing the regularization function 611 by constraining or guiding each element of the real-valued weight tensor (e.g., Wᵢ) towards each element of the estimated real-valued weight tensor Westⁱ may enable stabilization of the NN block 600. As will be noted from equation (7), given that binary weight values within the binary weight tensor Wᵢ^{b} are equal to +1 or −1, varying the scaling factor αᵢ results in proportionate changes to the estimated real-valued weight tensor Wᵢ. Thus, both the real-valued weight tensor Wᵢ and the scaling factor αᵢ can be updated in a subsequent iteration, which may enable the NN block to be trained more accurately. In this method, the scaling factor αᵢ and the real-valued weight tensor Wᵢ can be trained to collectively enable the regularization function 611 to be minimized. In some examples, as discussed in greater detail below, selection of the scaling factor αᵢ and the real-valued weight tensor Wᵢ is configured to take partial derivatives of the loss function with respect to the scaling factor αᵢ and partial derivatives of the loss function with respect to the real-valued weight real-valued weight tensor Wᵢ into consideration. In example embodiments, the regularization function 611 is minimized, meaning that the regularization function 611 is constrained or regularized towards zero by selecting values for the scaling factor αᵢ and values of elements of the real-valued weight Wᵢ during the forward pass of the kth iteration to enable the regularization function 611 to approximate zero.

In example embodiments, the loss function (Loss) 610 for an NN formed from a number (N) of successive NN blocks 600 (each block representing a respective ith NN layer), including the regularization function 611, is defined by equation (8):

Loss=a criterion function+sum_i(reg(αᵢ*Wᵢ^{b},Wᵢ)) (8)

Where the criterion function represents the differences between a computed output Y and a target output Y^{t} for the NN; In some examples, the criterion function is RSS representing residual sum of squares (e.g. RSS is the sum of squares of the differences between the computed output Y and a target output Y^{t} for the NN), in other examples, the criterion function is a cross-entropy function to measure differences between distributions of the computed output Y and distributions of a target output Y^{t} for the NN; sum_i is a summation of regularization functions in different layers (from 1 to N) of the NN, i is in the range from 1 to N; reg (αᵢ*Wᵢ^{b}, Wᵢ) represents the regularization function 611 with respect to the estimated real-valued weight tensor Westⁱ=αᵢ*Wᵢ^{b} and the real-valued weight tensor W. The estimated real-valued weight tensor Westⁱ=αᵢ*Wᵢ^{b} is related to the scaling factor αᵢ.

In some examples, the regularization function 611 is defined by either equation (9) or equation (10) as follows.

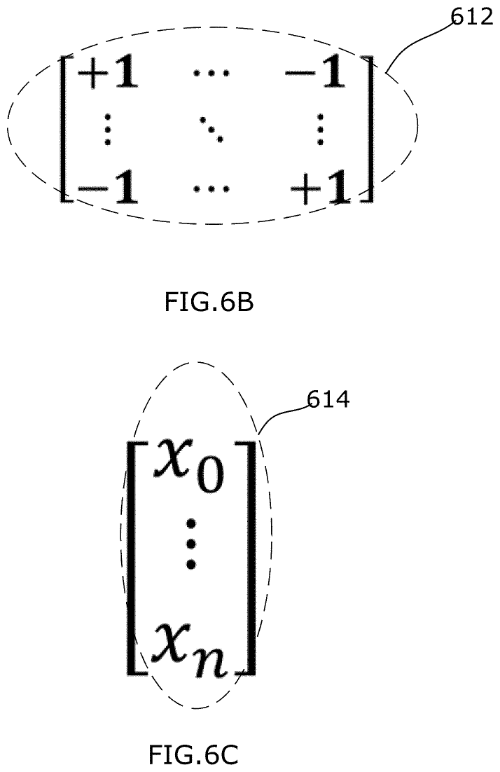

R₁(αᵢ,Wᵢ)=|αᵢ*Wᵢ^{b}−Wᵢ| (9)

Where R₁(.) is a regularization function that penalizes absolute value of a difference between αᵢ*Wᵢ^{b} and Wᵢ. FIG. 7A demonstrates a plot of the regularization function R₁(.) with respect to different scaling factors αᵢ. As shown in FIG. 7A, the solid plot is a regularization function R₁(.) in which αᵢ equals to 0.5, while the dotted plot is a symmetric regularization function R₁(.) in which αᵢ equals to 1.

R₂(αᵢ,Wⁱ)=(αᵢ*Wᵢ^{b}−Wᵢ)² (10)

Where R₂(.) is a regularization function that penalizes squared difference between αᵢ*Wᵢ^{b} and Wᵢ. FIG. 7B presents plots of the R₂(.) with respect to different scaling factors αᵢ. As shown in FIG. 7B, the solid plot is a regularization function R₂(.) in which αᵢ equals to 0.5, while the dotted plot is a symmetric regularization function R₂(.) in which αᵢ equals to 1.

As shown in FIGS. 7A and 7B, each of the regularization function plots is symmetric about the origin (e.g., at x=0 on the horizontal axis). In accordance with equations (9), (10), and FIGS. 7A and 7B, elements of the real-valued weight tensor Wⁱ will approximate to the estimated real-valued weight tensor Westⁱ=αᵢ*Wᵢ^{b}, in order to keep the regularization function 611 to be around zero. Such a regularization function penalizes the loss function, which may help to avoid overfitting and improve accuracy of training the NN in each iteration. In particular, even if there is noise in the input feature maps Xᵢ, as the regularization function 611 is encouraged to progress to near zero, elements of the real-valued weight tensor Wᵢ are pushed to be equal to −αᵢ or +αᵢ to enable the regularization function 611 (e.g. R₁ or R₂) be small enough to approach zero.

In some other examples, the regularization function 611 incorporated in the loss function 610 may be configured to include the features of both equation (9) and equation (10).

In the case of NN block 600 performing a binary convolution operation 606 and scaling operation 608, the use of the binary input feature map tensor XP and the binary weight tensor Wᵢ^{b} to perform binary convolution can reduce computational cost. At the same time, as the scaling factor αᵢ is used to generate an estimate real-valued weight tensor Westⁱ=αᵢ*Wᵢ^{b} to approximate the real-valued weight tensor Wⁱ, precision may be improved significantly compared with the case where only binary computation is involved in an NN block.

Furthermore, a symmetric regularization function 611 included in the loss function 610 may help to improve generalization of the NN block 600 and enable the scaling factor αᵢ and the real-valued weight tensor Wⁱ to be trained with greater accuracy. Moreover, the use of a regularization function 611 that penalizes the NN loss function 610 may enable the NN to be reliable and to be independent of inputs. Regardless of the training dataset, minor variation or statistical noise in input feature map tensors, the resulting NN may be applied to output a stable result.

Referring to FIG. 6F, an example of the calculation of partial derivatives ∂Loss/∂αᵢ, ∂Loss/∂Wᵢ of the loss function 610 with respect to different respective variables during a backward pass of the kth iteration on the ith layer will now be described according to example embodiments. The loss function Loss 610 as described in equation (8) is a function based on Wᵢ, Xᵢ, and αᵢ. As calculations of partial derivatives of the loss function with respect to Wᵢ and Xᵢ are similar, taking the loss function with respect to Wᵢ as an example, ∂Loss/∂Wᵢ is represented following equation (11):

∂Loss/∂Wᵢ=(∂Loss/∂Yᵢ)× . . . ×(∂Quantization/∂Wᵢ) (11)

However, as in the forward pass, the sign function as shown in FIG. 5A used to perform the quantization operation 602 is non-differentiable and inconsistent, the partial derivatives ∂Quantization/∂Wᵢ will be calculated inaccurately in the backward pass of the iteration. Thus, in some example embodiments, in the backward pass, each of the quantization operations 602, 604 is replaced with a smooth differentiable function that includes a sigmoid function. This done to approximate the sign function such that the derivative of the differentiable function approximates to the derivative of the sign function. In some examples, an identical differentiable function is utilized to perform both of the quantization operations 602, 604. In some other examples, two different respective differentiable functions are utilized to perform the quantization operations 602, 604 respectively. The differentiable function may be defined by equation (12) as below:

y_{β}(x)=2σ(βx)[1+βx(1−σ(βx))]−1 (12)

Where σ(.) is a sigmoid function; β is a parameter which is variable to control how fast the differentiable function converges to the sign function. In some examples, the differentiable function is an SSWISH function.

FIGS. 8A and 8B show two different examples of differentiable functions where two different respective parameters β are applied. FIG. 8A shows a differentiable function where β=2, and FIG. 8B shows a differentiable function where β=10. By comparing either plot representing a respective differentiable function as shown in FIGS. 8A and 8B with the sign function in FIG. 5A, it will be noted that as the differentiable function (represented by a plot in FIG. 8A or 8B) approximates to the sign function the differentiable function is smooth and consistent, thus the derivative of the differentiable function can approximate to the derivative of the sign function accurately. Such a method for employing a smooth differentiable function approximating the sign function during backward propagation may enable derivatives of the sign function to be calculated more accurately in backward pass, which may in turn help to improve accuracy of calculating the loss function Loss 610.

In some examples, prior to training the NN block 600, the NN block 600 is initialized with a pre-configured parameter set. In some applications, the smooth differentiable function, such as represented by a plot shown in FIG. 8A or 8B, may be used in both forward pass and backward pass to quantize the real-valued weight tensor and/or the real-valued input feature map tensor respectively. In some examples, in the initialization, the learning rate will be 0.1 and all the weights will be initialized to 1. Such a method to configure the NN block 600 may improve reliability and stability of the trained NN.

In the example embodiments, one or more smooth differentiable functions are used as the quantization functions in the backward pass, which may help to reduce inaccuracy incurred in calculating derivatives of the loss function with respect to real-valued input feature map tensor and derivatives of the loss function with respect to real-valued weight tensor.

Referring to FIGS. 6A and 6F again, a process for updating NN block 600 parameters, including the scaling factor αᵢ and the real-valued weight tensor Wⁱ, will now be discussed in greater detail. In the kth iteration on the ith layer of the NN, the ith NN block 600 generates an output Yᵢ for input feature map tensor X₁ based on a current set of parameters (e.g. real-valued weight tensor Wⁱ and a scaling factor αᵢ). The loss function Loss 610 is determined based on the generated output Yᵢ of the NN block 600 and includes the regularization function 611. For purpose of illustration, an updated real-valued weight tensor Wⁱ and an updated scaling factor αᵢ that are determined in the kth iteration are then applied in the k+1th iteration.

In the forward propagation in the kth iteration of the NN block 600, the regularization function 611 is minimized by collectively selecting values (e.g., α_{if}) for scaling factor and values of the real-valued weights (e.g., W_{if}) for the real-valued weight tensor that enable the estimated real-valued weight tensor Weightⁱ to approximate to the real-valued weight tensor Wᵢ.

During the backward propagation in the kth iteration, in accordance with partial derivatives ∂Loss/∂Wᵢ, a plurality of real-valued weight tensors Wᵢ, such as W_{ib1}, W_{ib2}, . . . , that enable to the loss function Loss to be minimized are calculated. In some examples, at least some scaling factor values of the scaling factorαᵢ, such as αᵢ_{_{b1}}, αᵢ_{_{b2}}, . . . , may be calculated that enable to the loss function Loss to be minimized.

Based on the calculated real-valued weight tensor and the calculated scaling factor that enable the regularization function to be minimized in the forward pass, and further based on the calculated the plurality of real-valued weight tensors and the calculated the plurality of scaling factors that enable the loss function to be minimized in the backward pass, a real-valued weight tensor and a scaling factor is selected to be utilized to update real-valued weight tensor and scaling factor in the k+1 th iteration (a subsequent iteration of the kth iteration). The updated real-valued weight tensor and the updated scaling factor will be applied in the ith layer of NN (e.g., NN block 600) in the k+1th iteration.

As the updated real-valued weight and the updated scaling factor enable the loss function to be minimized, the NN block is trained with additional accuracy.

In some examples, a gradient descent optimization function may be used in the backward propagation to minimize the loss. The real-valued weight Wⁱ and the scaling factor αᵢ may be trained to yield a smaller loss in a next iteration.

A summary of a method of training NN block 600 is illustrated in FIG. 6G. The method comprises: performing a first quantization operation on a real-valued feature map tensor to generate a corresponding binary feature map tensor; performing a second quantization operation on a real-valued weight tensor to generate a corresponding binary weight tensor; convoluting the binary feature map tensor with the binary weight tensor to generate a convoluted output; scaling the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor; calculating a loss function, the loss function including a regularization function configured to train the scaling factor so that the estimated weight tensor is guided towards the real-valued weight tensor; and updating the real-valued weight tensor and scaling factor based on the calculated loss function.

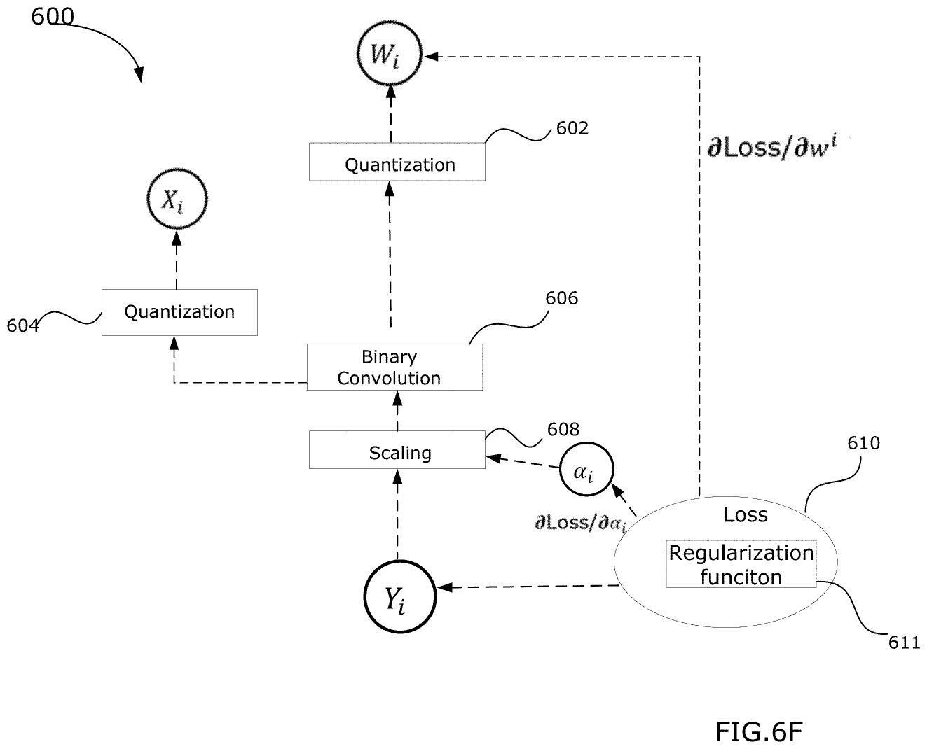

FIG. 9 is a block diagram of an example simplified processing unit 900, which may be used to execute machine executable instructions of an artificial neural network to perform a specific task (e.g., inference task) based on software implementations. The artificial neural network may include a NN block 600 as shown in FIG. 6A or FIG. 6F that is trained by using the training method discussed above. Other processing units suitable for implementing embodiments described in the present disclosure may be used, which may include components different from those discussed below. Although FIG. 9 shows a single instance of each component, there may be multiple instances of each component in the processing unit 900.

The processing unit 900 may include one or more processing devices 902, such as a processor, a microprocessor, an application-specific integrated circuit (ASIC), a field-programmable gate array (FPGA), a dedicated logic circuitry, a dedicated artificial intelligence processor unit, or combinations thereof. The processing unit 900 may also include one or more input/output (I/O) interfaces 904, which may enable interfacing with one or more appropriate input devices 914 and/or output devices 916. The processing unit 900 may include one or more network interfaces 906 for wired or wireless communication with a network (e.g., an intranet, the Internet, a P2P network, a WAN and/or a LAN) or other node. The network interfaces 906 may include wired links (e.g., Ethernet cable) and/or wireless links (e.g., one or more antennas) for intra-network and/or inter-network communications.

The processing unit 900 may also include one or more storage units 908, which may include a mass storage unit such as a solid state drive, a hard disk drive, a magnetic disk drive and/or an optical disk drive. The processing unit 900 may include one or more memories 910, which may include a volatile or non-volatile memory (e.g., a flash memory, a random access memory (RAM), and/or a read-only memory (ROM)). The non-transitory memory(ies) 910 may store instructions for execution by the processing device(s) 902, such as to carry out examples described in the present disclosure. The memory(ies) 910 may include other software instructions, such as for implementing an operating system and other applications/functions. In some examples, memory 910 may include software instructions for execution by the processing device 902 to implement a neural network that includes NN block 600 of the present disclosure. In some examples, the equations (1)-(12) and different kinds of algorithms (e.g., gradient optimization algorithms, quantization algorithms, etc.,) may be stored within the memory 910 along with the different respective parameters discussed in the equations (1)-(12). The processing device may execute machine executable instructions to perform each operation of the NN block 600 as disclosed herein, such as quantization operation, convolution operation and scaling operations using the equations (1)-(10) stored within the memory 910. The processing device may further execute machine executable instructions to perform backward propagation to train the real-valued weight and scaling factors using the equations (11)-(12) stored within the memory 910.

In some other examples, one or more data sets and/or modules may be provided by an external memory (e.g., an external drive in wired or wireless communication with the processing unit 900) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 912 providing communication among components of the processing unit 900, including the processing device(s) 902, I/O interface(s) 904, network interface(s) 906, storage unit(s) 909 and/or memory(ies) 910. The bus 912 may be any suitable bus architecture including, for example, a memory bus, a peripheral bus or a video bus.

As shown in FIG. 9, the input device(s) 914 (e.g., a keyboard, a mouse, a microphone, a touchscreen, and/or a keypad) and output device(s) 916 (e.g., a display, a speaker and/or a printer) are shown as external to the processing unit 900. In other examples, one or more of the input device(s) 914 and/or the output device(s) 916 may be included as a component of the processing unit 900. In other examples, there may not be any input device(s) 914 and output device(s) 916, in which case the I/O interface(s) 904 may not be needed.

It will thus be appreciated that the NN block 600 trained by the method described herein may be applied for performing inference tasks in various scenarios. For example, the NN block 600 can be useful for a deep neural network system that is deployed into edge devices like robotic, drone, camera and IoT sensor devices, among other things.

In some examples, a NN system (e.g., deep neural network system) may implement a NN block (e.g., NN block 600) implemented as a layer of an NN. The NN may be a software that includes machine readable instructions that may be executed using a processing unit, such as a neural processing unit. Alternatively, the NN may be a software that includes machine readable instructions that be executed by a dedicated hardware device, such as a compact, energy efficient AI chip that includes a small number of logical gates.

The present disclosure provides examples in which a trainable scaling factor is applied on an output of a binary convolution operation, which helps to save computational cost and improve precision of NN. A regularization function with respect to an estimated real-valued weight tensor including the scaling factor and a real-valued weight tensor is included in a loss function of a NN to train the scaling factor. Such a method enables the regularization function to be close to zero in forward pass of iteration, which may help to improve generalization of the NN. Moreover, the scaling factor and the real-valued weight tensor can be trained to satisfy the criteria set in the regularization, which may enable the NN associated with the scaling factor and the real-valued weight tensor to be trained accurately.

In at least one application, one or more smooth differential functions are used as quantization functions to quantize the real-valued weight tensor and quantize the real-valued input feature map tensor. In this regard, partial derivatives with respect to the real-valued weight tensor and the real-valued input feature map tensor are calculated with great accuracy.

In some examples, the smooth differentiable functions may be used both in backward pass and forward pass to approximate the sign function to quantize real-valued weight tensors and real-valued feature map tensors when the NN block is being initialized.

In some implementations, the NN block trained by a method of the present disclosure may perform inference tasks in various applications. The inferences tasks may include facial recognition, object detections, image classification, machine translation, or text-to-speech transition.

Image Classification

Facial recognition is a technology that capable of identifying or verifying a person from an image or a video. Recently, CNN-based facial recognition techniques have become more and more popular. A typical CNN-based facial recognition algorithm contains two parts, feature extractor and identity classifier. The feature extractor part focus on extracting high-level features from face images and the identity classifier part determine the identity of face image based on the extracted features.

In general, the feature extractor is a CNN model whose design and training strategy should encourage it to extract robust, representative and discriminative features from face images. The identity classifier can be any classification algorithm, including DNNs. The identity classifier should determine whether the extracted features from input face image match any face features already stored in the system.

The method of the present invention can be applied on the training procedure of the feature extractors and on the training procedure of some types of identity classifiers to encourage them converging into a binary network.

An example of CNN-based facial recognition algorithm is Deep ID family. These models contain one or more deep CNNs as feature extractors. The proposed loss function are specially designed to encourage them to extract identity-rich features from face images.

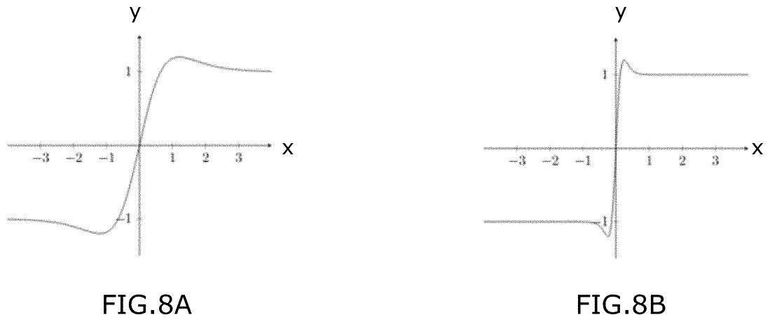

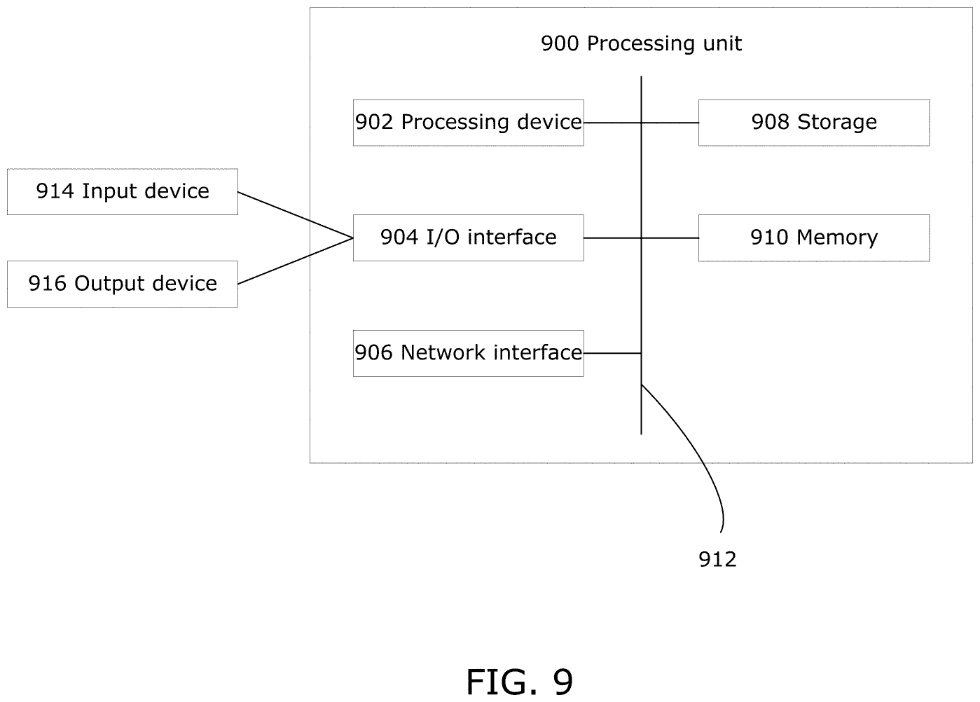

FIG. 12 presents the ConvNet architecture of DeepID2 feature extractor

Take DeepID2 as an example, its feature extraction process is denoted as f=ConvNet(x,θc), where ConvNet(⋅) is the feature extraction function defined by ConvNet, x is the input face image, f is the extracted DeepID2 vector, and θ_{c} denotes ConvNet parameters to be learned. To be specific, for the ConvNet architecture described in FIG. 12, θ_{c}={w,p} where w is the weight of filters of convolution layers and p is other learnable parameters.

The model is trained under two supervisory signals which are identification loss and verification loss, which trained the parameters of identity classifier θ_{id} and the parameters of feature extractor θᵥₑ respectively.

Ident(f,t,θ_{id})=Σᵢ₌₁ⁿ−pᵢ log \hat{p}ᵢ=−log \hat{p}ₜ

Where the identification loss is cross-entropy between target identity distribution pᵢ and output distribution from identity classifier \hat{p}ᵢ, where pᵢ=0 for all i except pₜ=1 for the target class t.

$$Verif ( {f}_{i} , {f}_{j} , {y}_{ij} , {θ}_{ve} ) = \{ \begin{matrix}\frac{1}{2} {‖ {f}_{i} - {f}_{j} ‖}_{2}^{2} & if {y}_{ij} = 1 \\ \frac{1}{2} {max ( 0 , m - {‖ {f}_{i} - {f}_{j} ‖}_{2} )}^{2} & if {y}_{ij} = - 1\end{matrix}$$

The final loss is weighted sum of identification loss and verification loss. λ controls the relative strength of identification signal and verification signal.

Loss=Ident(f,t,θ_{id})+λ*Verif(fᵢ,fⱼ,yᵢⱼ,θᵥₑ)

The original algorithm for training DeepID2 model is shown in Table 1.

TABLE 1
The DeepID2 learning algorithm

```
input: training set χ = {(xᵢ,lᵢ)} , initialized parameters θ_{c} , θ_{id} and θᵥₑ ,
hyperparameter λ,
    learning rate η(t), t ← 0
while not converge do
  t ← t + 1 sample two training samples (xᵢ,lᵢ) and (xⱼ,lⱼ) from χ
  fᵢ = ConvNet(xᵢ,θ_{c}) and fⱼ = ConvNet(xⱼ,θ_{c})
  $\text{∇} {θ}_{id} = \frac{\partial Ident ( {f}_{i} \text{,} {l}_{i} \text{,} {θ}_{id} )}{\partial {θ}_{id}} + \frac{\partial Ident ( {f}_{j} \text{,} {l}_{j} \text{,} {θ}_{id} )}{\partial {θ}_{id}}$
  $\begin{matrix}\text{∇} {θ}_{ve} = λ \cdot \frac{\partial Verif ( {f}_{i} \text{,} {f}_{j} \text{,} {y}_{ij} \text{,} {θ}_{ve} )}{\partial {θ}_{ve}} , where {y}_{ij} = 1 if {l}_{i} = {l}_{j} , and {y}_{ij} = - 1 \\ otherwise .\end{matrix}$
  $\text{∇} {f}_{i} = \frac{\partial Ident ( {f}_{i} \text{,} {l}_{i} \text{,} {θ}_{id} )}{\partial {f}_{i}} + λ \cdot \frac{\partial Verif ( {f}_{i} \text{,} {f}_{j} \text{,} {y}_{ij} \text{,} {θ}_{ve} )}{\partial {f}_{i}}$
  $\text{∇} {f}_{j} = \frac{\partial Ident ( {f}_{j} \text{,} {l}_{j} \text{,} {θ}_{id} )}{\partial {f}_{j}} + λ \cdot \frac{\partial Verif ( {f}_{i} \text{,} {f}_{j} \text{,} {y}_{ij} \text{,} {θ}_{ve} )}{\partial {f}_{j}}$
  $\text{∇} {θ}_{c} = \text{∇} {f}_{i} \cdot \frac{\partial ConvNet ( {x}_{i} \text{,} {θ}_{c} )}{\partial {θ}_{c}} + \text{∇} {f}_{j} \cdot \frac{\partial ConvNet ( {x}_{j} \text{,} {θ}_{c} )}{\partial {θ}_{c}}$
  update θ_{id} − η(t) · ∇θ_{id}, θᵥₑ − η(t) · ∇θᵥₑ and θ_{c} − η(t) · ∇θ_{c}.
end while
output θ_{c}
```

The 1-bit CNN training approach of the present invention can be applied on the feature extractor ConvNet(xᵢ,θ_{c}) to encourage this model converging into a binary network ConvNet_{Bin}(xᵢ,θ_{BC}) and speed up the feature extraction process. Where θ_{BC}={α_{BC},w_{b},p} is learnable parameters of 1-bit CNN, w_{b}∈{−1,+1} is binary filter weights, α_{Bc} is the scale factors for each filter, p is other learnable parameters.

To convert ConvNet(xᵢ, θ_{c}) into ConvNet_{Bin}(xᵢ, θ_{BC}), following modification need to be applied,

Remove L₁, L₂-regularizers which drives weights toward zero.

Replace activation function ReLU with SSWISH function

Replace all conv2d(xᵢ,w) operations with its binary counterpart α_{BC}·conv2d_{bin}(xᵢ, w_{b})

Preserve all max pooling layers

Applied the proposed regularizer reg(⋅) on w

Loss=Ident(f,t,θ_{id})+λ*Verif(fᵢ,fⱼ,yᵢⱼ,θᵥₑ)+λ_{reg}*reg(α_{BC},w)

The new model can be trained with the modified algorithm described in Table 2. In the modified training algorithm, θ_{c} update is divided into two parts, ∇w and ∇p, due to our regularization term only apply on w.

TABLE 2
The modified DeepID2 learning algorithm

```
input: training set χ = {(xᵢ,lᵢ), initialized parameters w, α_{BC}, p, θ_{id} and θᵥₑ,
hyperparameter λ and λ_{reg}, learning rate η(t), t ← 0
while not converge do
  t ← t + 1 sample two training samples (xᵢ,lᵢ) and (xⱼ,lⱼ) from χ
  w_{b} = sign(w)
  θ_{BC} = {α_{BC},w_{b},p)
  fᵢ = ConvNet_{Bin}(xᵢ,θ_{BC}) and fⱼ = ConvNet_{Bin}(xⱼ,θ_{BC})
  $\text{∇} {θ}_{id} = \frac{\partial Ident ( {f}_{i} \text{,} {l}_{i} \text{,} {θ}_{id} )}{\partial {θ}_{id}} + \frac{\partial Ident ( {f}_{j} \text{,} {l}_{j} \text{,} {θ}_{id} )}{\partial {θ}_{id}}$
  $\begin{matrix}\text{∇} {θ}_{ve} = λ \cdot \frac{\partial Verif ( {f}_{i} \text{,} {f}_{j} \text{,} {y}_{ij} \text{,} {θ}_{ve} )}{\partial {θ}_{ve}} , where {y}_{ij} = 1 if {l}_{i} = {l}_{j} , and {y}_{ij} = - 1 \\ otherwise .\end{matrix}$
  $\text{∇} {f}_{i} = \frac{\partial Ident ( {f}_{i} \text{,} {l}_{i} \text{,} {θ}_{id} )}{\partial {f}_{i}} + λ \cdot \frac{\partial Verif ( {f}_{i} \text{,} {f}_{j} \text{,} {y}_{ij} \text{,} {θ}_{ve} )}{\partial {f}_{i}}$
  $\text{∇} {f}_{j} = \frac{\partial Ident ( {f}_{j} \text{,} {l}_{j} \text{,} {θ}_{id} )}{\partial {f}_{j}} + λ \cdot \frac{\partial Verif ( {f}_{i} \text{,} {f}_{j} \text{,} {y}_{ij} \text{,} {θ}_{ve} )}{\partial {f}_{j}}$
  $\begin{matrix}\text{∇} w = \text{∇} {f}_{i} \cdot \frac{\partial {ConvNet}_{Bin} ( {x}_{i} \text{,} {θ}_{Bc} )}{\partial {w}_{b}} + \text{∇} {f}_{j} \cdot \frac{\partial {ConvNet}_{Bin} ( {x}_{j} \text{,} {θ}_{Bc} )}{\partial {w}_{b}} + \\ {λ}_{reg} \frac{\partial reg ( w \text{,} {α}_{BC} )}{\partial w}\end{matrix}$
  $\text{∇} p = \text{∇} {f}_{i} \cdot \frac{\partial {ConvNet}_{Bin} ( {x}_{i} \text{,} {θ}_{Bc} )}{\partial p} + \text{∇} {f}_{j} \cdot \frac{\partial {ConvNet}_{Bin} ( {x}_{j} \text{,} {θ}_{Bc} )}{\partial p}$
  $\text{∇} {α}_{BC} = {λ}_{reg} \frac{\partial reg ( w , {α}_{BC} )}{\partial {α}_{BC}}$
  ∇θ_{C} = {∇w,∇p}
  update θ_{id} − η(t) · ∇θ_{id}, θᵥₑ − η(t) · ∇θᵥₑ, θ_{c} − η(t) · ∇θ_{c} and α_{BC} −
  η(t) · ∇α_{BC}.
end while
output w, w_{b} and α_{BC}
```

A complete facial recognition system often contains face detection algorithm, which detect facial regions on the input image, and face alignment algorithm, which improve facial recognition accuracy by aligning face images. Some of these algorithms are also based on neural networks which can be accelerated with the method of the present invention.

Although deep-learning based facial recognition system achieved very good accuracy, the computational cost also increased compared with traditional methods. The present invention helps to alleviate this problem.

Large-scale facial recognition system, like city security monitoring system, aim to match input face with huge amount of registered faces. In this case, the computational cost of facial recognition is dominated by the identity classifier. However, the registration process for large amount of faces could be very slow. The method of the present invention when implemented on the training of feature extractor helps to accelerate this process. Furthermore, the regularizer of the present invention can also apply on the neural activations. The activation quantization encourages the feature extractor extract low-bit features which can greatly reduce the computational cost of identity classifier.

For small facial recognition system deployed on mobile devices, the number of registered faces are small so system performance is dominated by the feature extractor. Facial recognition systems that implement the method of the present invention are expected to be response faster and more energy-efficient. The bandwidth requirement for model deployment is also reduced since the model is compressed.

Object Detection

Object detection is a computer vision technology that finding instances of semantic objects of certain class in input images or videos. The object detection system output regression results for object locations and classification results for object labels. This embodiment shows how to apply our approach on the deep-learning systems with mixture types of output.

There are two mainstream approaches used to build CNN-based object detection pipeline.

Two-Stage Approach

Two-stage object detection approach is also known as proposal-driven approach. This type of methods predicting the object location at first stage and predicting the object type at second stage. In the first stage, a region proposal method is used to propose a sparse set of candidate object locations on the input image. The raw image pixels or extracted features of candidate object locations are pre-processed then feed into the second stage. In the second stage, a classifier is trained to classify each candidate object locations as one of the foreground classes or as background class.

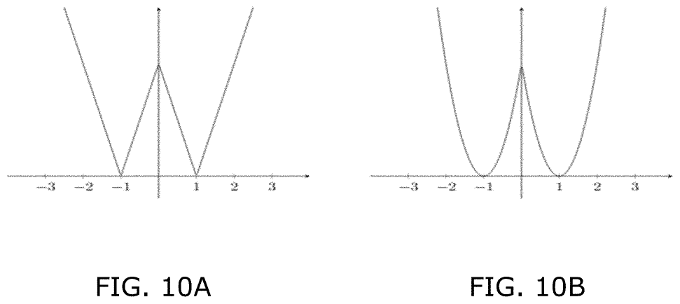

FIG. 14 presents one-stage approach (YOLO)

One-Stage Approach

One-stage object detection approach output the prediction of object locations and object labels in one shot. These methods divide the input image into a grid. A DNN is trained to generate one vector for each cell in the grid. The output vector for each cell should contains label prediction and candidate location predictions for the objects inside or partially included in this cell.

At the end of one-stage or two-stage approaches, multiple candidate object locations and corresponding predicted labels are obtained. Bounding box aggregation approaches are used to combine this information and generate final output.

For two-stage approach, we expect our approach at least can apply on the feature extractor and the classifier and for the one-stage approach, our approach should be able to accelerate the whole object detection pipeline.

The most famous two-stage object detection approaches are R-CNN family. R-CNN [Girshick et al. (2013) (citation provided below)] and Fast R-CNN [Girshick (2015) (citation provided below)] use selective search, a traditional region proposal method, at the first stage.

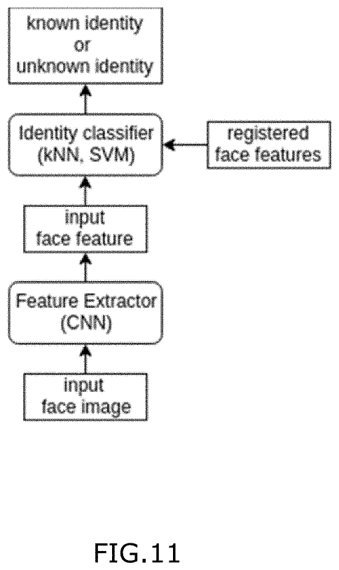

FIG. 15 shows Faster R-CNN diagram

The selective search is the main performance bottleneck of Fast R-CNN pipeline. In order to solve this problem, Faster R-CNN defines lots of anchors on the image. Region proposal network (RPN) is trained to provide bounding boxes refinement for each anchor and the likelihood that an object included in the proposed region.

For the second stage, the corresponding cropped-and-resized raw images or feature maps of every proposed regions are fed into the classifier to predict the label for the proposed region. In the end, all proposed regions and their predicted labels are aggregated to generate the final prediction for input image. In the Faster R-CNN framework, RPN was trained with following multi-task loss.

L({pᵢ},{tᵢ})=(1/N_{cis})ΣᵢL_{cis}(pᵢ,pᵢ*)+Δ(1/N_{reg})Σᵢpᵢ*L_{reg}(t,tᵢ*)

where i is the index of an anchor in the grid, pᵢ/pᵢ* are the foreground/background prediction/label and tᵢ/tᵢ* are the bounding box regression prediction/ground truth. pᵢ**L_{reg} term means only foreground anchors contribute to regression loss.

One of the training strategy of Faster R-CNN is alternating training. In this training strategy, we first train RPN, and use the proposals to train the classifier. The network tuned by the training of classifier will be used as the initialization of RPN in next iteration.

To implement the 1-bit CNN training approach of the present invention on Faster R-CNN model, the following modifications are applied,

Remove L₁, L₂-regularizers which drives weights toward zero.

Replace activation function ReLU with SSWISH function

Replace all conv2d(xᵢ,w) operations with its binary counterpart α_{BC}. conv2d_{bin}(xᵢ,w_{b})

Preserve all max pooling layers

To make sure CNN converge into a binary network, a regularizer is applied on w during the trainings of both RPN and classifier. Therefore, the training loss of RPN become,

$$L ( \{ {p}_{i} \} , \{ {t}_{i} \} ) = ( 1 / {N}_{cls} ) {Σ}_{i} {L}_{cls} ( {p}_{i} , {p}_{i}^{*} ) + λ ( \frac{1}{{N}_{reg}} ) {Σ}_{i} {p}_{i}^{*} {L}_{reg} ( t , {t}_{i}^{*} ) + {λ}_{reg} reg ( w , {α}_{BC} )$$

where w and α_{BC} is the weights and scaling factors of the binary network.

For all R-CNN models, the present invention can apply on the training of CNN classifier at the second stage and encourage the CNN classifier to be a binary network. Specifically, the present invention adds a regularizer to this training loss to encourage a binary RPN.

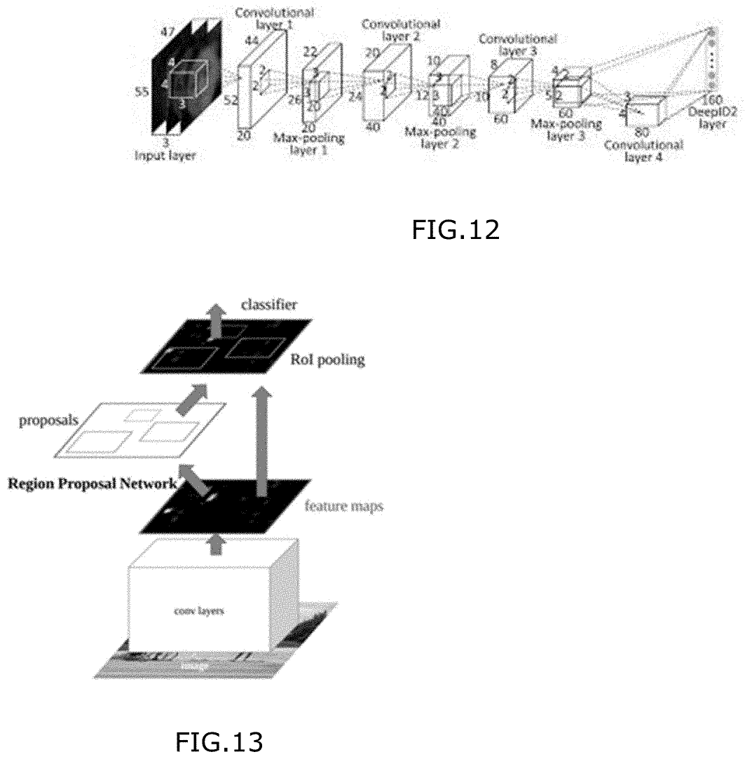

FIG. 16 shows YOLO diagram.

YOLO and SSD are very representative one-stage approaches. In this type of frameworks, only one CNN is trained to predict both candidate object locations and dense object labels for the input image simultaneously so our approach can directly apply on the training procedure of this CNN and is beneficial to the whole framework.

Although Faster R-CNN and YOLO already achieved nearly real-time performance on desktop GPU, real-time object detection on mobile devices, especially on devices without dedicated neural network acceleration hardware, are still a very challenging task. The present invention allows us to train a binary network which has less computational cost and is more suitable for running on CPU. The present invention reduces hardware costs, improve device battery life and allow the model to be deployed on more platforms.

Gesture Detection

Gesture recognition system is a type of man-machine interface being developed vigorously in recent years. Compared with facial recognition and object detection task, gesture is hard to be recognized only based on one single frame. Therefore, most gesture recognition systems use video data as input. The method of the present invention can be implemented in a gesture recognition system as described below.

2D CNN

The most straight forward approach for handling video input is directly applying 2D CNN models on each frame to generate a sequence of labels. The prediction sequence can be somehow aggregated along time to improve the prediction accuracy.

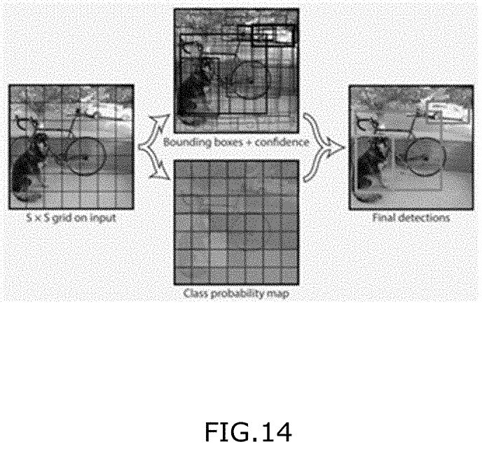

FIG. 17 shows 2D CNN approach

Since image datasets are more common and accessible than video datasets, this approach allow the model trained with huge amount of data. On the other hand, prediction accuracy is not very good since the model can only consider spatial inter-relations of pixels while their temporal neighbors are ignored, which is critical for gesture recognition task.

Motion-Based Features

To achieve good performance on gesture recognition task, temporal information rather than spatial data must be better considered in the model. Instead of feeding raw frames, another approach to handle video input is feeding hand-crafted motion-based features (for instance, optical flow) into the 2D CNN.

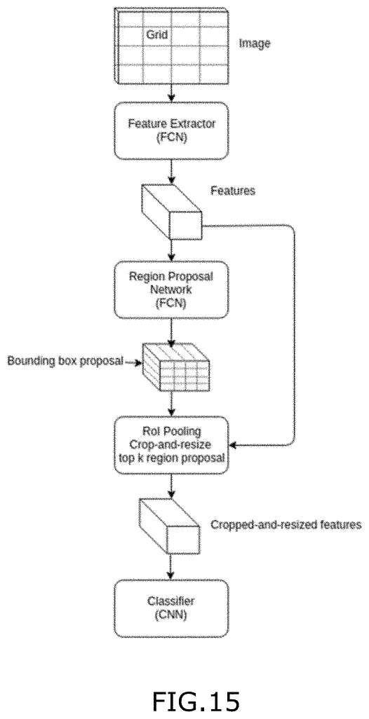

FIG. 18 is motion-based feature approach

The advantages of this type of approaches is there are already exist many accurate and efficient methods (software algorithm or dedicated hardware) to compute these hand-crafted features. The computational speed can be very fast. But not like the CNN filters which are directly learned from data set, hand-crafted features may not robust or efficient to represent the dataset.

Another point worth to mention is that several hand-crafted motion-based features can be computed with DNN model. In this case, our approach can also apply on these models and improve their performance. For instance, [Fischer et al. (2015) (citation provided below)] (FlowNet) proposed a methodology that generate high-quality optical flow features based on fully convolutional network (FCN).

3D CNN

3D CNN is another solution to handle temporal data. Multiple neighboring frames can be combined together to build a 3D tensor. A popular choice is stacking multiple frames along channel axis to build a thick 3D tensor. Feeding these tensors directly into a 3D CNN allows the model learn the best temporal filters working this data set.

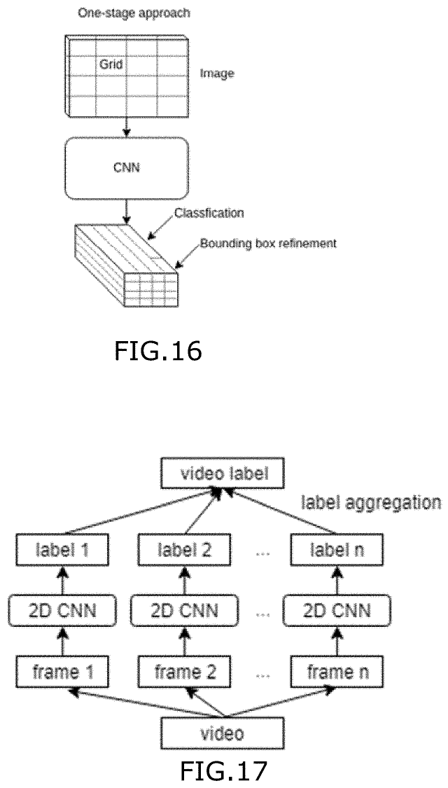

FIG. 19 is 3D CNN approach. On the other hand, due to the limitation of CNN architecture, this approach only able to handle fixed-length input. However, in the gesture recognition task, neither all gestures cost same time nor all people wave their hands in the same speed. Another limitation of this approach is the input tensor size. If we combined too many frames into one input tensor, the computation of CNN will be very expensive thus 3D CNN approach cannot handle very long time dependency.

Temporal Deep-Learning Model (RNN, LSTM)

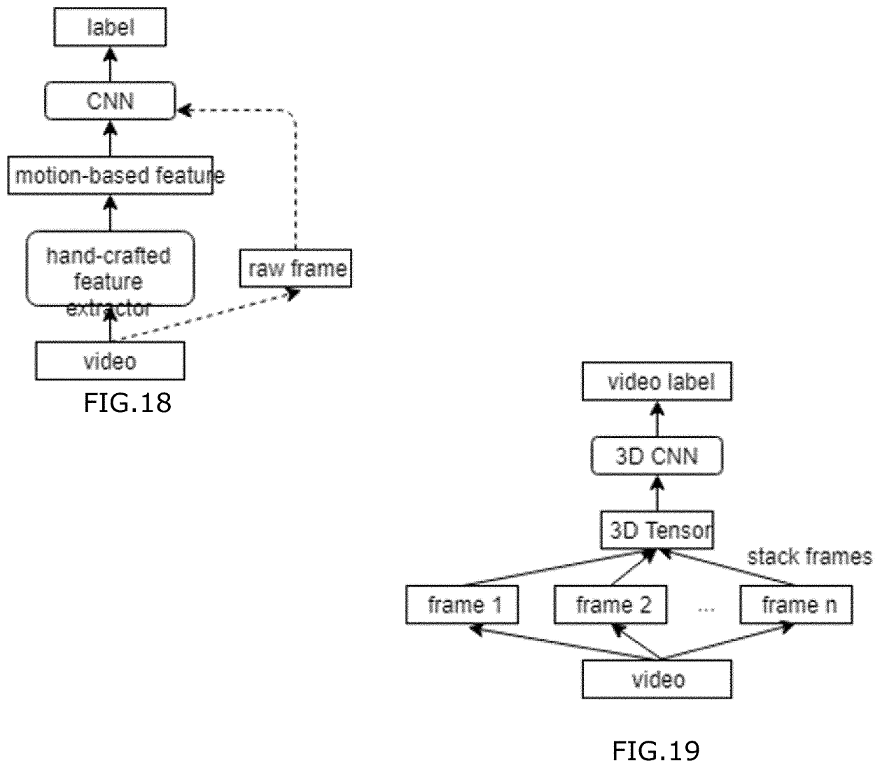

FIG. 20 is temporal deep-learning model approach

Video is a sequence of images, so naturally, temporal deep learning models can be used for gesture recognition task. Compared with 3D CNN, RNN model allow us feeding variable-length input data into the network so it allows the model to handle video in arbitrary length and also capable to capture long time dependency.

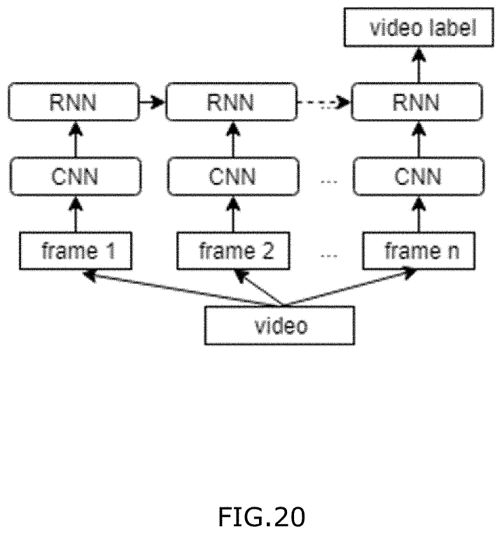

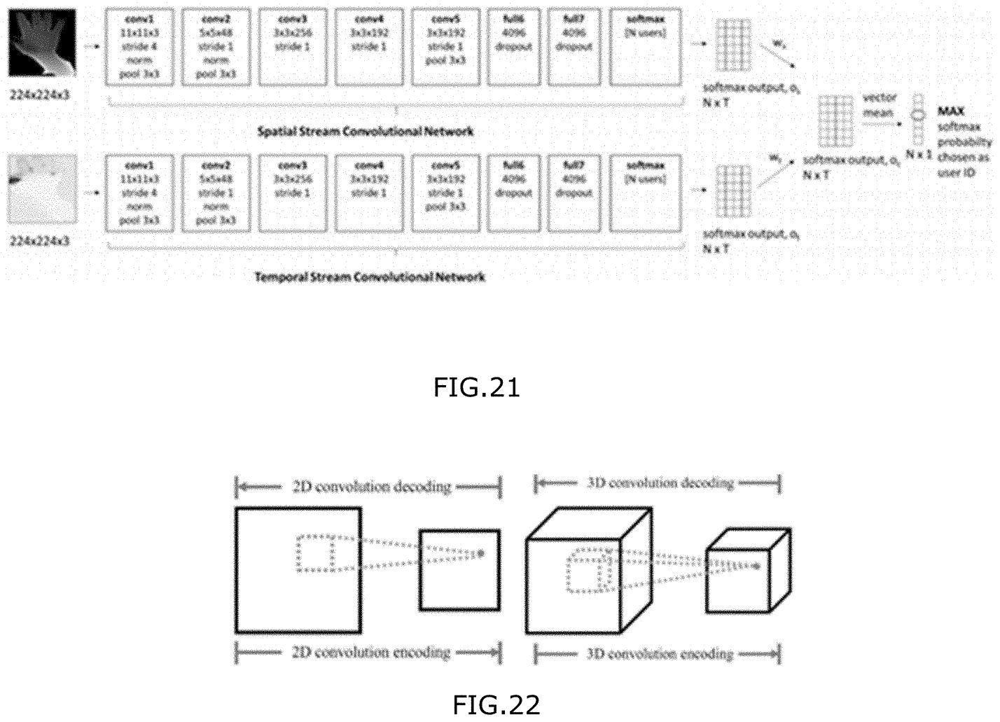

In most cases, the size of raw input images are too large for RNN architecture. A popular solution for this problem is training a CNN as feature extractor and use it to compress the input data size before fed into RNN. This architecture also known as convolutional recurrent neural network (C-RNN). FIG. 21 shows a two-stream CNN architecture.

[Wu et al. (2016a) (citation provided below)] proposed a two-stream (spatio-temporal) CNN which use raw depth data captured by Microsoft Kinect as the input of spatial network and optical flow as the input of temporal one. The outputs from spatial network and temporal network are combined as the final prediction. Our regularizer can be added to the final training loss to encourage both spatial CNN and temporal CNN converge into a binary network. FIG. 22 is a 2D convolution and 3D convolution.

[Huang et al. (2015) (citation provided below)] proposed a methodology that solving sign language recognition problem with 3D CNN. The model extracts discriminating spatio-temporal features from raw video stream automatically without any prior knowledge, avoiding designing features. In this case, our approach can be applied on 3D CNN in the same manner of 2D CNN.

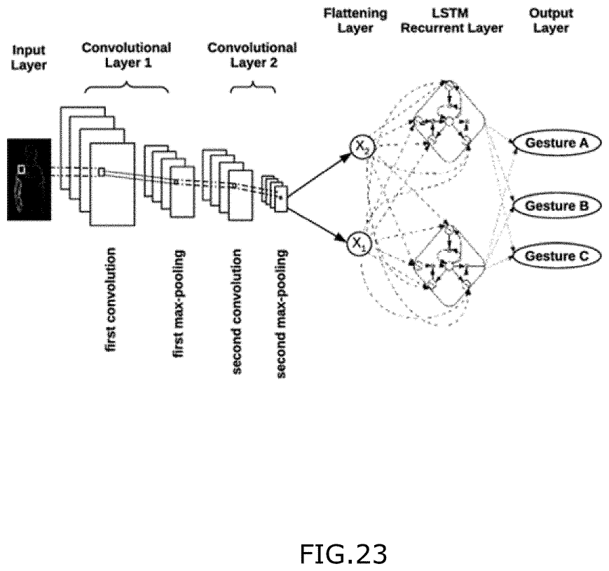

FIG. 23 demonstrates CNN-LSTM architecture.

A Convolutional Long Short-Term Memory Recurrent Neural Network (CNNLSTM) able to successfully learn gesture varying in duration and complexity. In this architecture, a CNN model is used to extract high-level features from raw image and LSTM model used to decode the sequence of high-level features.

The deep-learning based gesture recognition system that implements the method of the present invention runs much faster than the same model architecture without the present invention. Power consumption and inference speed is also improved.

Under same computational budget, the deep-learning based gesture recognition system that implements the method of the present invention can output more predictions within same amount of time which can provide smoother user experience or output the prediction based on more frames which helps to improve both robustness and accuracy.

Sentiment Analysis

Sentiment analysis, also known as opinion mining, is the computational study of people's opinions, sentiments, emotions, appraisals, and attitudes towards entities such as products, services, organizations, individuals, issues, events, topics, and their attributes. In recent years, deep learning has emerged as a powerful machine learning technique and popularly used in sentiment analysis.

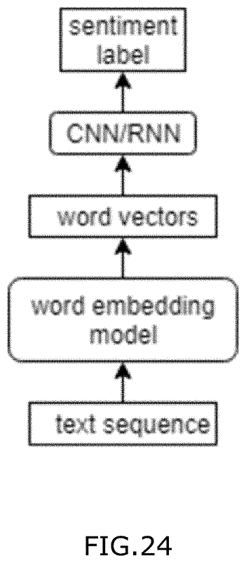

Unlike other computer vision tasks above, sentiment analysis is a natural language processing task whose input data is text, which make it a good example for showing how to implement this approach on a text processing system. A typical deep-learning based sentiment analysis system contains word embedding model which maps each single word to its embedding vector in the embedding space. By using word embedding model, text data, like sentences and articles, can be converted into a sequence of fixed-length vectors so DNN models can be trained on the top of embedded data to predict sentiment label of the text and solved the sentiment analysis problem. FIG. 24 shows sentiment analysis diagram.

Deep-learning based sentiment analysis architectures are very diverse. In general, the method of the present invention can be applied on the CNN/RNN part, which maps the embedded word sequence to sentiment label.

[Severyn and Moschitti (2015) (citation provided below)] proposed a sentiment analysis architecture which combines word2vec word embedding model and deep CNN model to predict the emotional labels. In this paper, author used L₂-regularizer to avoid overfitting. However, this regularizer is not compatible with the method of the present invention approach since it drives the weights toward 0. The L₂-regularizer should be replaced with the regularizer of the present invention.

[Dos dos Santos and Gatti (2014) (citation provided below)] proposed a Character to Sentence CNN (CharSCNN) model which uses two convolutional layers to extract relevant features from words and sentences of any size to perform sentiment analysis of short texts. This CNN model also can be quantized and accelerated with the approach proposed in this patent.

The present invention can speed up the large-scale sentiment analysis system which will be particularly useful for Advertisement Company and E-business Company. This approach also allows the deployment of complex sentiment analysis model on small personal device which enhances AI virtual assistant performance.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure, as listed below, are incorporated herein by reference.
[Courbariaux et al. (2015)] M. Courbariaux, Y. Bengio, and J.-P. David. Binaryconnect: Training deep neural networks with binary weights during propagations. In Advances in neural information processing systems, pages 3123-3131, 2015.
[Hubara et al. (2016)] I. Hubara, M. Courbariaux, D. Soudry, R. El-Yaniv, and Y. Bengio. Binarized neural networks. In Advances in neural information processing systems, pages 4107-4115, 2016.
[Russakovsky et al. (2015)] O. Russakovsky, J. Deng, H. Su, J. Krause, S. Satheesh, S. Ma, Z. Huang, A. Karpathy, A. Khosla, M. Bernstein, et al. Imagenet large scale visual recognition challenge. International Journal of Computer Vision, 115 (3): 211-252, 2015.
[Gong et al. (2014)] Y. Gong, L. Liu, M. Yang, and L. Bourdev. Compressing deep convolutional networks using vector quantization. arXiv preprint arXiv:1412.6115, 2014.
[Wu et al. (2016b)] J. Wu, C. Leng, Y. Wang, Q. Hu, and J. Cheng. Quantized convolutional neural networks for mobile devices. In Proceedings of the IEEE Conference on Computer Vision and Pattern Recognition, pages 4820-4828, 2016.
[Rastegari et al. (2016)] M. Rastegari, V. Ordonez, J. Redmon, and A. Farhadi. Xnor-net: Imagenet classification using binary convolutional neural networks. In European Conference on Computer Vision, pages 525-542. Springer, 2016.
[Zhou et al. (2016)] S. Zhou, Y. Wu, Z. Ni, X. Zhou, H. Wen, and Y. Zou. Dorefa-net: Training low bitwidth convolutional neural networks with low bitwidth gradients. arXiv preprint arXiv:1606.06160, 2016.
[Tang et al. (2017)] W. Tang, G. Hua, and L. Wang. How to train a compact binary neural network with high accuracy? In AAAI, pages 2625-2631, 2017.
[Mishra et al. (2017)] A. Mishra, E. Nurvitadhi, J. J. Cook, and D. Marr. Wrpn: wide reduced-precision networks. arXiv preprint arXiv:1709.01134, 2017.
[Cai et al. (2017)] Z. Cai, X. He, J. Sun, and N. Vasconcelos. Deep learning with low precision by half-wave gaussian quantization. arXiv preprint arXiv:1702.00953, 2017.
[Gudovskiy and Rigazio (2017)] D. A. Gudovskiy and L. Rigazio. Shiftcnn: Generalized low-precision architecture for inference of convolutional neural networks. arXiv preprint arXiv:1706.02393, 2017.
[Wu et al. (2018)] S. Wu, G. Li, F. Chen, and L. Shi. Training and inference with integers in deep neural networks. arXiv preprint arXiv:1802.04680, 2018.
[Girshick et al. (2013)] R. B. Girshick, J. Donahue, T. Darrell, and J. Malik. Rich feature hierarchies for accurate object detection and semantic segmentation. CoRR, abs/1311.2524, 2013. URL http://arxiv.org/abs/1311.2524.
[Girshick (2015)] R. B. Girshick. Fast R-CNN. CoRR, abs/1504.08083, 2015. URL http://arxiv.org/abs/1504.08083.
[Fischer et al. (2015)] P. Fischer, A. Dosovitskiy, E. Ilg, P. Häusser, C. Hazirbas, V. Golkov, P. van der Smagt, D. Cremers, and T. Brox. Flownet: Learning optical flow with convolutional networks. CoRR, abs/1504.06852, 2015. URL http://arxiv.org/abs/1504.06852.
[Wu et al. (2016a)] J. Wu, P. Ishwar, and J. Konrad. Two-stream cnns for gesture-based verification and identification: Learning user style. In Proceedings of the IEEE Conference on Computer Vision and Pattern Recognition Workshops, pages 42-50, 2016.
[Huang et al. (2015)] J. Huang, W. Zhou, H. Li, and W. Li. Sign language recognition using 3d convolutional neural networks. In Multimedia and Expo (ICME), 2015 IEEE International Conference on, pages 1-6. IEEE, 2015.
[Severyn and Moschitti (2015)] A. Severyn and A. Moschitti. Twitter sentiment analysis with deep convolutional neural networks. In Proceedings of the 38th International ACM SIGIR Conference on Research and Development in Information Retrieval, pages 959-962. ACM, 2015.
[dos Santos and Gatti (2014)] C. dos Santos and M. Gatti. Deep convolutional neural networks for sentiment analysis of short texts. In Proceedings of COLING 2014, the 25th International Conference on Computational Linguistics: Technical Papers, pages 69-78, 2014.

1. A method of training a neural network (NN) block for a neural network, comprising:
performing a first quantization operation on a real-valued feature map tensor to generate a corresponding binary feature map tensor;
performing a second quantization operation on a real-valued weight tensor to generate a corresponding binary weight tensor;
convoluting the binary feature map tensor with the binary weight tensor to generate a convoluted output;
scaling the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor;
calculating a loss function, the loss function including a regularization function configured to train the scaling factor so that the estimated weight tensor is guided towards the real-valued weight tensor; and
updating the real-valued weight tensor and scaling factor based on the calculated loss function.

2. The method of claim 1 comprising, during backpropagation, using differential functions that include a sigmoid function to represent the first quantization operation and the second quantization operation.

3. The method of claim 2 wherein the differentiable function is:
y_{β}(x)=2σ(βx)[1+βx(1−σ(βx))]−1, wherein:
σ(.) is a sigmoid function;
β is a parameter which is variable that controls how fast the differentiable function converges to a sign function; and
X is the quantized value.

4. The method of claim 1 comprising wherein the first quantization operation and the second quantization operation each include a differential functions that include a sigmoid function.

5. The method of claim 1 wherein the regularization function is based on an absolute difference between the estimated weight tensor and the real-valued weight tensor.

6. The method of claim 1 wherein the regularization function is based on a squared difference between the estimated weight tensor and the real-valued weight tensor.

7. The method of claim 1 wherein the scaling factor includes non-binary real values.

8. The method of claim 1 wherein the neural network includes N of the NN blocks, and the loss function is:
Loss=a criterion function+sum_i(reg(αᵢ*Wᵢ^{b},Wᵢ))
where the criterion function represents differences between a computed output and a target output for the NN, sum_i is a summation of the regularization functions in different blocks 1 to N of the neural network, i is in the range from 1 to N; and reg (αᵢ*Wᵢ^{b}, Wᵢ) represents the regularization function where αᵢ*Wᵢ^{b} is the estimated weight tensor and Wᵢ is the real-valued weight tensor Wᵢ.

9. A processing unit implementing an artificial neural network, comprising:
a neural network (NN) block configured to:
perform a first quantization operation on a real-valued feature map tensor to generate a corresponding binary feature map tensor;
perform a second quantization operation on a real-valued weight tensor to generate a corresponding binary weight tensor;
convolute the binary feature map tensor with the binary weight tensor to generate a convoluted output;
scale the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor; a training module configured to:
calculate a loss function, the loss function including a regularization function configured to train the scaling factor so that the estimated weight tensor is guided towards the real-valued weight tensor; and
update the real-valued weight tensor and scaling factor based on the calculated loss function.

10. The processing unit of claim 9, wherein during backpropagation differential functions that include a sigmoid function are used as to represent the first quantization operation and the second quantization operation.

11. The processing unit of claim 10, wherein the differentiable function is:
y_{β}(x)=2σ(βx)[1+βx(1−σ(βx))]−1, wherein:
σ(.) is a sigmoid function;
β is a parameter which is variable that controls how fast the differentiable function converges to a sign function; and
X is the quantized value.

12. The processing unit of claim 9, wherein during forward propagation the first quantization operation and the second quantization operation each include a differential functions that include a sigmoid function.

13. The processing unit of claim 9, wherein the regularization function is based on an absolute difference between the estimated weight tensor and the real-valued weight tensor.

14. The processing unit of claim 9, wherein the regularization function is based on a squared difference between the estimated weight tensor and the real-valued weight tensor.

15. The processing unit of claim 9, wherein the scaling factor includes non-binary real values.

16. The processing unit of claim 9, wherein the neural network includes N of the NN blocks, and the loss function is:
Loss=a criterion function+sum_i(reg(αᵢ*Wᵢ^{b},Wᵢ))
where the criterion function represents differences between a computed output and a target output for the NN, sum_i is a summation of the regularization functions in different blocks 1 to N of the neural network, i is in the range from 1 to N; and reg (αᵢ*Wᵢ^{b}, Wᵢ) represents the regularization function where αᵢ*Wᵢ^{b} is the estimated weight tensor and Wᵢ is the real-valued weight tensor Wᵢ.

17. A non-transitory computer-readable medium storing instructions which, when executed by a processor of a processing unit cause the processing unit to perform a method of training a neural network (NN) block for a neural network, comprising:
performing a first quantization operation on a real-valued feature map tensor to generate a corresponding binary feature map tensor;
performing a second quantization operation on a real-valued weight tensor to generate a corresponding binary weight tensor;
convoluting the binary feature map tensor with the binary weight tensor to generate a convoluted output;
scaling the convoluted output with a scaling factor to generate a scaled output, wherein the scaled output is equal to an estimated weight tensor convoluted with the binary feature map tensor, the estimated weight tensor corresponding to a product of the binary weight tensor and the scaling factor;
calculating a loss function, the loss function including a regularization function configured to train the scaling factor so that the estimated weight tensor is guided towards the real-valued weight tensor; and
updating the real-valued weight tensor and scaling factor based on the calculated loss function.
